(19) United States
(12) Patent Application Publication
(10) Pub. No.: US 2016/0214415 A1
(43) Pub. Date: Jul. 28, 2016

(54) Printer

(71) Applicant: Brother Kogyo Kabushiki Kaisha, Nagoya-shi (JP)

(72) Inventor: Junya Kawai, Kiyosu-shi (JP)

(21) Appl. No.: 15/002,470

(22) Filed: Jan. 21, 2016

(30) Foreign Application Priority Data
Jan. 23, 2015 (JP) 2015-011069

(51) Int. Cl. B41J 15/04; B41J 3/407

(52) U.S. Cl. CPC B41J 15/04; B41J 3/4075

(57) ABSTRACT

The disclosure discloses a printer includes a storage part, a feeding roller, a printing head, a core driving device, a controller. The controller is configured to execute a feeding process, a printing process, a taking-up process, a torque correction process. In the taking-up process, the core driving device is driven to sequentially taking up a printed tape around an outer circumferential portion of a second core into a roll shape. In the torque correction process, a drive torque of the core driving device is corrected from a first drive torque to a second drive torque, the first drive torque corresponding to the absence of a slip between the feeding roller and a tape to be printed in contact with the feeding roller, the second drive torque corresponding to a tape remaining amount of the tape in a roll of tape to be printed.

### CROSS-REFERENCE TO RELATED APPLICATION

The present application claims priority from Japanese Patent Application No. 2015-011069, which was filed on Jan. 23, 2015, the disclosure of which is incorporated herein by reference in its entirety.

### BACKGROUND

1. Field

The present disclosure relates to a printer forming a desired print on a tape to be printed.

2. Description of the Related Art

A printer is known that forms a desired print on a tape to be printed. This printer of prior art includes a feeding roller and a printing head. The tape to be printed is fed out from a roll of tape to be printed and is fed by the feeding roller. On the tape to be printed being fed, the printing head forms a desired print at a desired printing speed to turn the tape to be printed into a printed tape. The printed tape is then sequentially taken up around an outer circumferential portion of a core driven by a core driving device into a roll shape.

The feeding/taking-up behavior as described above causes forces to act on the tape to be printed both at the time of contact and feeding by the feeding roller and at the time of taking-up by the core. At the time of feeding/taking-up as described above, a slip may occur between the feeding roller and the tape to be printed for some reason.

For example, when a tape remaining amount is relatively large in the roll of tape to be printed, the tape to be printed can be pulled out from the outer diameter side of the roll with relatively small force and, therefore, a slip easily occurs in a tape advance direction relative to the feeding roller. In this case, the occurrence of the slip in the tape advance direction makes a tape feeding speed slightly faster between a printing speed and the tape feeding speed that would otherwise be synchronized with each other. As a result, the print is formed in a form elongated in the feeding direction of the tape to be printed as compared to an intended form of print formation (a so-called print length is made longer).

For example, when a tape remaining amount is relatively small in the roll of tape to be printed, a relatively large force is required for pulling out the tape to be printed from the outer diameter side of the roll and, therefore, conversely, a slip easily occurs in a tape delay direction relative to the feeding roller. In this case, the occurrence of the slip in the tape delay direction makes the tape feeding speed slightly slower between the printing speed and the tape feeding speed that would otherwise be synchronized with each other. As a result, the print is formed in a form shortened in the feeding direction of the tape to be printed as compared to the intended form of print formation (a so-called print length is made shorter).

### SUMMARY

It is an object of the present disclosure to provide a printer capable of preventing an increase and a decrease in tape feeding speed due to a slip between a feeding roller and a tape to be printed so as to prevent a deterioration in printing quality.

In order to achieve the above-described object, according to the aspect of the present application, there is provided a printer comprising a storage part configured to store a roll of a tape to be printed with a tape to be printed wound around an outer circumferential portion of a first core, a feeding roller, a printing head that is disposed facing the feeding roller, a core driving device, and a controller, the controller being configured to execute a feeding process for driving the feeding roller to contact and feed the tape fed out from the roll stored in the storage part, a printing process for controlling the printing head to form a desired print at a desired printing speed on the tape fed by the feeding process, thereby turning the tape into a printed tape, a taking-up process for driving the core driving device to sequentially taking up the printed tape around an outer circumferential portion of a second core into a roll shape, and a torque correction process for correcting a drive torque of the core driving device from a first drive torque to a second drive torque, the first drive torque corresponding to the absence of a slip between the feeding roller and the tape in contact with the feeding roller, the second drive torque corresponding to a tape remaining amount of the tape in the roll.

A printer of the present disclosure includes the feeding roller and the printing head. The tape to be printed is fed out from the first core of the roll of the tape to be printed stored in the storage part and is fed by the feeding roller. On the tape being fed, the printing head forms a desired print at a desired printing speed to turn the tape into the printed tape. The printed tape is then sequentially taken up around the outer circumferential side of the second core (driven by the core driving device) into a roll shape. The feeding/taking-up behavior as described above causes forces to act on the tape to be printed both at the time of contact and feeding by the feeding roller and at the time of taking-up by the second core. In the present disclosure, the drive torque of the core driving device is normally controlled to the desired first drive torque (that is a theoretical value) corresponding to the absence of a slip between the feeding roller and the tape to be printed so as to smoothly feed and take up the tape while keeping the balance between these two forces.

When the drive torque is controlled as described above, a slip may occur between the feeding roller and the tape for some reason.

For example, when a tape remaining amount is relatively large in the roll of the tape, the tape can be pulled out from the outer diameter side of the roll with relatively small force and, therefore, a slip easily occurs in a tape advance direction relative to the feeding roller. In this case, the occurrence of the slip in the tape advance direction makes a tape feeding speed slightly faster between a printing speed and the tape feeding speed that would otherwise be synchronized with each other. As a result, the print is formed in a form elongated in the feeding direction of the tape as compared to an intended form of print formation (a so-called print length is made longer).

For example, when a tape remaining amount is relatively small in the roll, a relatively large force is required for pulling out the tape from the outer diameter side of the roll and, therefore, conversely, a slip easily occurs in a tape delay direction relative to the feeding roller. In this case, the occurrence of the slip in the tape delay direction makes the tape feeding speed slightly slower between the printing speed and the tape feeding speed that would otherwise be synchronized with each other. As a result, the print is formed in a form shortened in the feeding direction of the tape as compared to the intended form of print formation (a so-called print length is made shorter).

Therefore, in the present disclosure, a controller executes a torque correction process. In this torque correction process, the drive torque of the core driving device is corrected from the first drive torque to the second drive torque in accordance with the tape remaining amount. If a slip occurs in the tape advance direction as described above, the torque can be set to the second drive torque smaller than the first drive torque to prevent an increase in the tape feeding speed. As a result, the elongated form of print formation can be prevented to form a print in a correct form. If a slip occurs in the tape delay direction as described above, the torque can be set to the second drive torque larger than the first drive torque to prevent a decrease in the tape feeding speed. As a result, the shortened form of print formation can be prevented to form a print in a correct form.

### BRIEF DESCRIPTION OF DRAWINGS

FIG. 1 is a perspective view of an exterior appearance of a printer of a first embodiment of the present disclosure.

FIG. 2 is a side cross-sectional view of an internal structure of the printer.

FIG. 3 is a perspective view of the exterior appearance of the printer with a first openable cover, a second openable cover, and a front openable cover opened.

FIG. 4 is a perspective view of the printer with the first openable cover, the second openable cover, and the front openable cover opened and with a tape cartridge and an ink ribbon cartridge removed.

FIG. 5 is a perspective view of an overall configuration of the tape cartridge.

FIG. 6 is a perspective view of an overall configuration of the ink ribbon cartridge.

FIG. 7 is a functional block diagram of a structure of a control system of the printer.

FIG. 8 is a circuit diagram of a circuit connection configuration between a CPU and a motor drive circuit.

FIG. 9A is an explanatory view of the case of a printing form elongated due to occurrence of a slip.

FIG. 9B is an explanatory view of the case of a printing form elongated due to occurrence of a slip.

FIG. 10 is an exemplary correction amount table indicative of a correction amount of a first voltage command value.

FIG. 11 is an explanatory view of an example of a correction technique for the first voltage command value using the correction amount table.

FIG. 12 is a flowchart of a control procedure executed by the CPU.

FIG. 13 is a flowchart of a detailed procedure of step S100.

FIG. 14 is an exemplary correction amount table indicative of a correction amount of the first voltage command value in a modification example of a simplified correction amount setting mode.

FIG. 15 is an exemplary correction amount table indicative of a correction amount of the first voltage command value in a modification example of a simplified correction amount setting mode.

FIG. 16 is an explanatory diagram of an example of a correction amount calculation technique based on calculation using a calculation formula parameter in a modification example for calculating a correction amount without using a correction amount table.

### DETAILED DESCRIPTION OF THE PREFERRED EMBODIMENTS

An embodiment of the present disclosure will now be described with reference to the drawings. If “front,” “rear,” “left,” “right,” “top,” and “bottom” are noted in the drawings, “front,” “rear,” “left,” “right,” “top (above),” and “bottom (under)” in the description indicate the noted directions.

### <General Configuration of Printer>

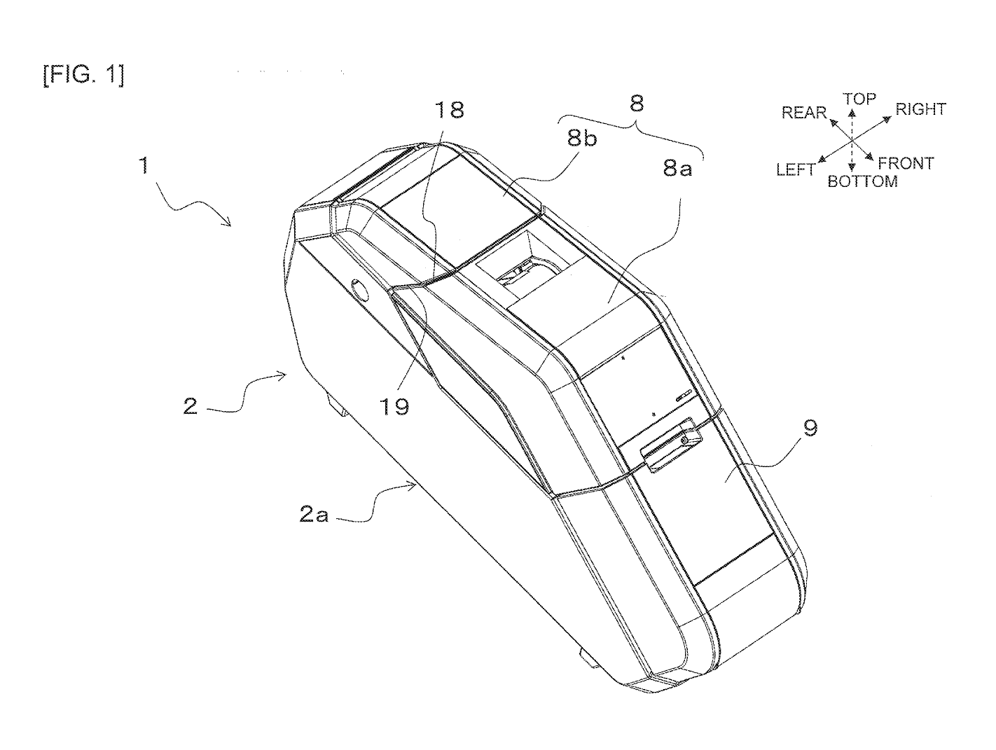

A general configuration of a printer of this embodiment will be described with reference to FIGS. 1 to 4.

### <Housing>

As shown in FIGS. 1 to 4, a printer 1 of this embodiment has a housing 2 making up an outer contour of the printer. The housing 2 includes a housing main body 2a, a rear openable portion 8, and a front openable cover 9.

The housing main body 2a includes therein a first storage part 3 disposed to the rear side as well as a second storage part 5 and a third storage part 4 disposed to the front side.

The rear openable portion 8 is connected to an upper portion on the rear side of the housing main body 2a in an openable manner. The rear openable portion 8 can rotate to open and close the top of the first storage part 3. The rear openable portion 8 is made up of a first openable cover 8a and a second openable cover 8b.

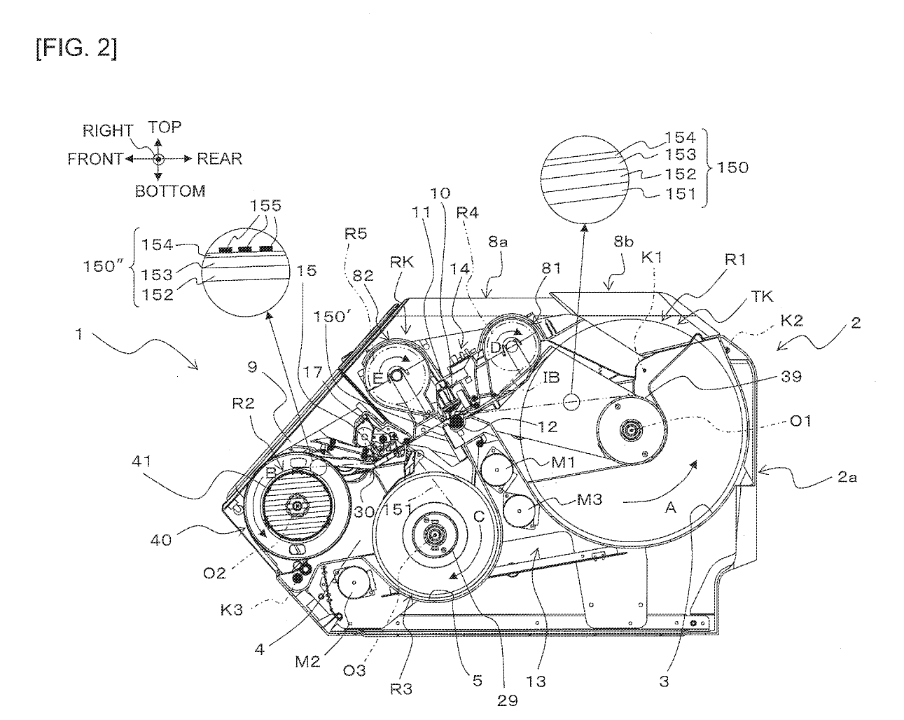

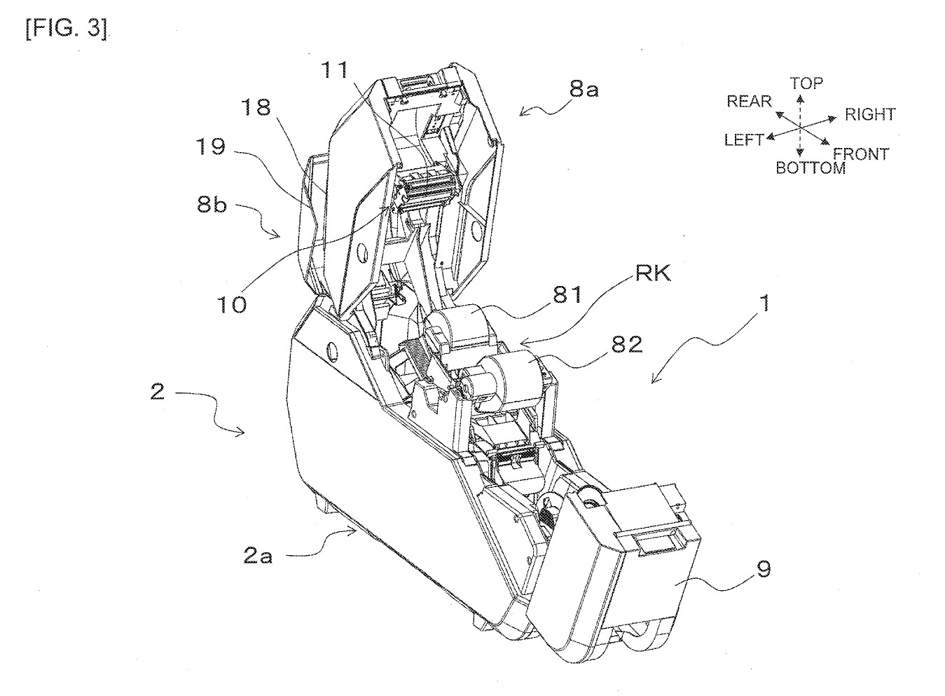

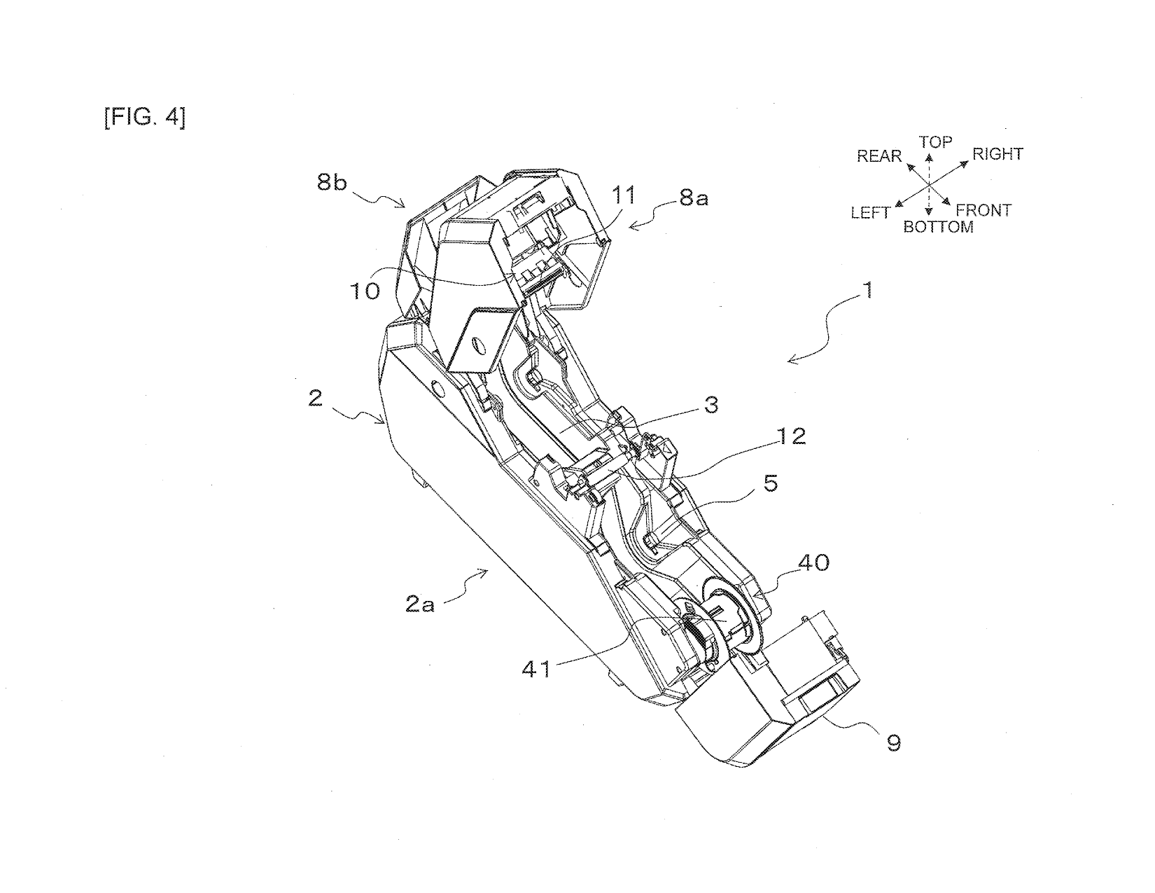

The first openable cover 8a can rotate around a rotation axis K1 located at the upper portion on the rear side of the housing main body 2a to open and close the top on the front side of the first storage part 3. Specifically, the first openable cover 8a can rotate from a closing position covering the top on the front side of the first storage part 3 (a state of FIGS. 1 and 2) to an opening position exposing the top on the front side of the first storage part 3 (a state of FIGS. 3 and 4).

A head holder 10 including a printing head 11 (described later in detail) is disposed inside the first openable cover 8a. The first openable cover 8a can rotate around the rotation axis K1 to move the printing head 11 away from/close to a feeding roller 12 (described later in detail) disposed on the housing main body 2a. Specifically, the first openable cover 8a can rotate from the closing position at which the printing head 11 is located close to the feeding roller 12 (the state of FIGS. 1 and 2) to the opening position at which the printing head 11 is located away from the feeding roller 12 (the state of FIGS. 3 and 4).

The second openable cover 8b is disposed to the rear side relative to the first openable cover 8a and can rotate around a rotation axis K2 located at an upper end portion on the rear side of the housing main body 2a to open and close the top on the rear side of the first storage part 3 separately from opening/closing of the first openable cover 8a. Specifically, the second openable cover 8b can rotate from a closing position covering the top on the rear side of the first storage part 3 (the state of FIGS. 1 and 2) to an opening position exposing the top on the rear side of the first storage part 3 (the state of FIGS. 3 and 4).

When both the first and second openable covers 8a, 8b are in the closing state, an outer circumferential portion 18 of the first openable cover 8a is substantially in contact with an edge 19 of the second openable cover 8b to substantially entirely cover the top of the first storage part 3.

The front openable cover 9 is connected to an upper portion on the front side of the housing main body 2a in an openable manner. The front openable cover 9 can rotate around a rotation axis K3 located at an upper end portion on the front side of the housing main body 2a to open and close the top of the third storage part 4. Specifically, the front openable cover 9 can rotate from a closing position covering the top of the third storage part 4 (the state of FIGS. 1 and 2) to an opening position exposing the top of the third storage part 4 (the state of FIGS. 3 and 4).

### <Adhesive Tape Roll and Periphery Thereof>

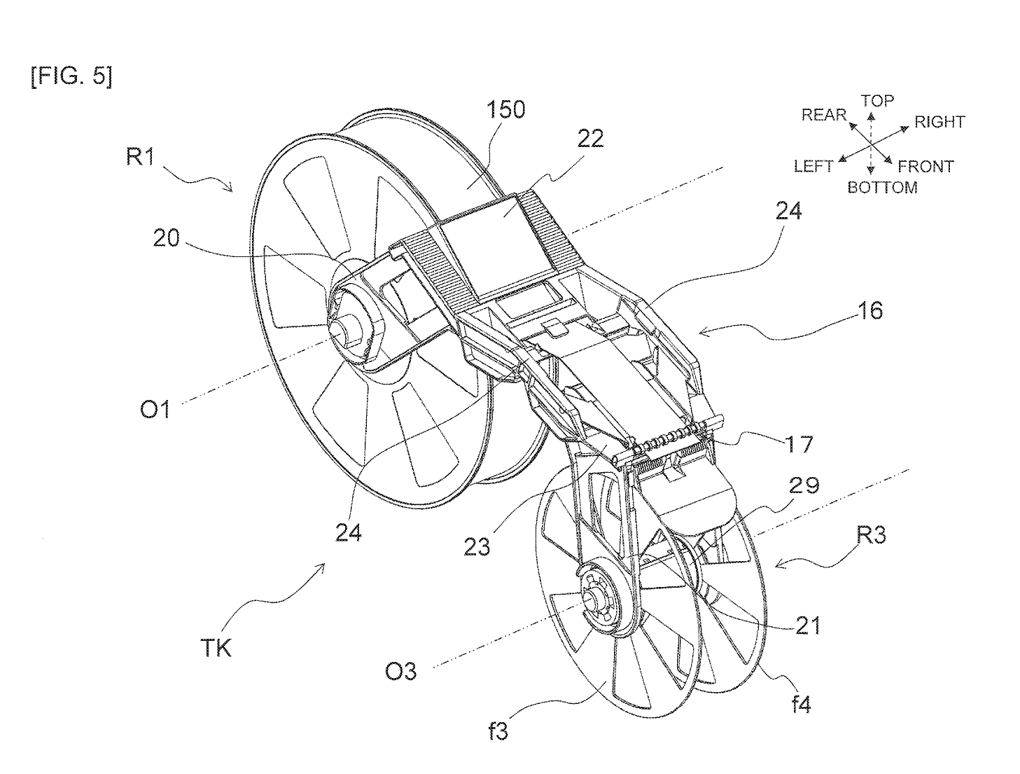

As shown in FIGS. 2 to 4, a tape cartridge TK is detachably mounted on the housing main body 2a at a first predetermined position 13 located under the front openable cover 9 in the closing state. The tape cartridge TK includes an adhesive tape roll R1 wound and formed around an axis O1. FIG. 5 shows a detailed structure of the tape cartridge TK.

As shown in FIG. 5, the tape cartridge TK includes the above described adhesive tape roll R1 and a coupling arm 16. The coupling arm 16 includes a pair of left and right first bracket portions 20, 20 disposed to the rear side, and a pair of left and right second bracket portions 21, 21 disposed to the front side.

The first bracket portions 20, 20 sandwich the adhesive tape roll R1 from both the left and right sides along the axis O1, and rotatably hold the adhesive tape roll R1 around a core 39 (see FIG. 2) while the tape cartridge TK is mounted on the housing main body 2a. These first bracket portions 20, 20 are connected at upper end portions through a first connecting portion 22 extended substantially along the left-right direction while avoiding interference with the outer diameter of the adhesive tape roll R1.

The adhesive tape roll R1 is freely rotatable when the tape cartridge TK is mounted inside the housing main body 2a. In the adhesive tape roll R1, an adhesive tape 150 to be fed out and consumed is wound around an outer circumferential portion of the above described core 39 in advance.

As shown in FIG. 2, when the tape cartridge TK is mounted, the adhesive tape roll R1 is received from above and stored in the first storage part 3 with the axis O1 of winding of the adhesive tape 150 defined in the left-right direction. While being stored in the first storage part 3 (while the tape cartridge TK is mounted), the adhesive tape roll R1 rotates in a predetermined rotation direction (direction A in FIG. 2) in the first storage part 3 to feed out the adhesive tape 150.

In the case described in this embodiment, the above described adhesive tape 150 used is a tape to be printed having adhesiveness. Therefore, the adhesive tape 150 has a print-receiving layer 154, a base layer 153, an adhesive layer 152, and a separation material layer 151 laminated in this order in a thickness direction from one side (the top side in a partially enlarged view of FIG. 2) toward the other side (the bottom side in the partially enlarged view of FIG. 2). The print-receiving layer 154 is a layer on which a desired print portion 155 (see a partially enlarged view of FIG. 2) is formed through heat transfer printing with ink by the above described printing head 11. The adhesive layer 152 is a layer for affixing the base layer 153 to a suitable adherend (not shown). The separation material layer 151 is a layer covering the adhesive layer 152.

### <Feeding Roller and Printing Head>

As shown in FIGS. 2 to 4, the above described feeding roller 12 is disposed to a top middle side of the first and second storage parts 3, 5 in the housing main body 2a. The feeding roller 12 is driven via a gear mechanism (not shown) by a first motor M1 that is, for example, a pulse motor, disposed inside the housing main body 2a, and thereby contacts the adhesive tape 150 fed out from the adhesive tape roll R1 stored in the first storage part 3 and feeds the adhesive tape 150 in a posture with a width direction (tape width direction) defined as the left-right direction while being in contact with the adhesive tape 150.

As described above, the above described head holder 10 disposed on the first openable cover 8a includes the above described printing head 11. The printing head 11 can be moved away from/close to the feeding roller 12 by rotating the first openable cover 8a around the rotation axis K1 as described above. In particular, when the first openable cover 8a is in the closing state, the printing head 11 is located close to the feeding roller 12, and when the first openable cover 8a is in the opening state, the printing head 11 is located away from the feeding roller 12. The printing head 11 is disposed on the head holder 10 at a position facing the top of the feeding roller 12 in the closing state of the first openable cover 8a, so as to sandwich and support the adhesive tape 150 fed by the feeding roller 12 in cooperation with the feeding roller 12. Therefore, if the first openable cover 8a is in the closing state, the printing head 11 and the feeding roller 12 are arranged facing each other in the top-bottom direction. On the above described print-receiving layer 154 of the adhesive tape 150 sandwiched with the feeding roller 12, the printing head 11 forms a desired print (the above described print portion 155) at a desired printing speed set in advance (e.g., a printing speed synchronized with a feeding speed (a tape feeding speed) of the adhesive tape 150) with a known technique by using an ink ribbon IB of an ink ribbon cartridge RK described later, thereby turning the adhesive tape 150 into a printed adhesive tape 150′.

### <Ink Ribbon Cartridge>

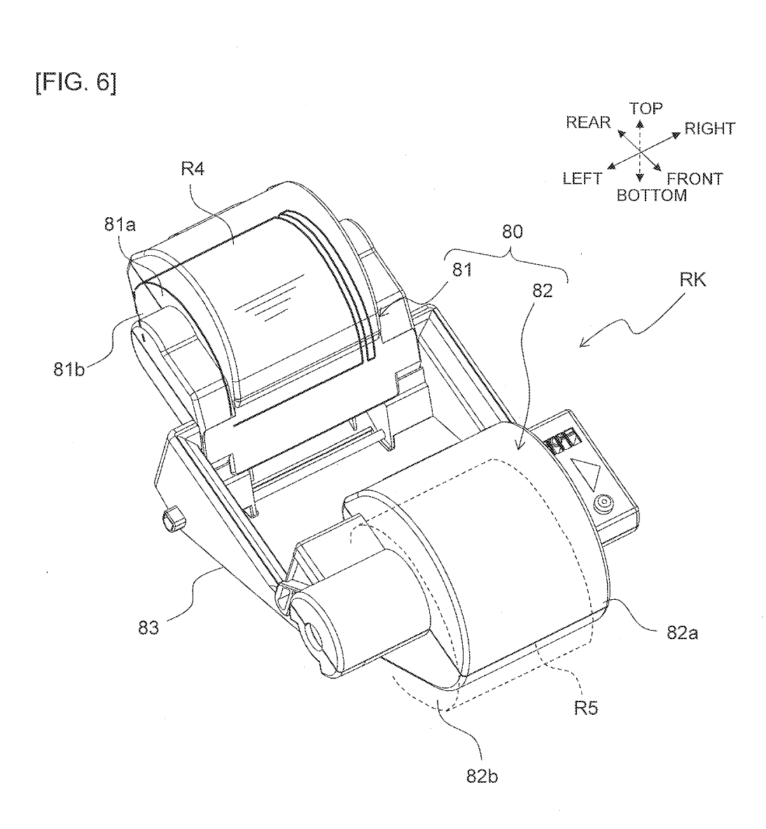

As shown in FIGS. 2 and 3, the ink ribbon cartridge RK is detachably mounted on a second predetermined position 14 under the first openable cover 8a and above the tape cartridge TK in the closing state of the housing main body 2a. FIG. 6 shows a detailed structure of the ink ribbon cartridge RK.

As shown in FIGS. 2, 3, and 6, the ink ribbon cartridge RK includes a cartridge housing 80, a ribbon feed-out roll R4 that is the unused wound ink ribbon IB capable of being fed out for print formation by the printing head 11, and a ribbon take-up roll R5. The cartridge housing 80 has a feed-out roll storage part 81 on the rear side, a take-up roll storage part 82 on the front side, and a coupling portion 83. The coupling portion 83 couples the take-up roll storage part 82 and the feed-out roll storage part 81 such that the ink ribbon IB fed out from the ribbon feed-out roll R4 is exposed outside the cartridge housing 80.

The feed-out roll storage part 81 is formed by combining a substantially half-cylindrical upper portion 81a with a lower portion 81b. The ribbon feed-out roll R4 is freely rotatably supported in the feed-out roll storage part 81 and rotates in a predetermined rotation direction (direction D of FIG. 2) in a mounted state of the ink ribbon cartridge RK so as to feed out the ink ribbon IB.

The take-up roll storage part 82 is formed by combining a substantially half-cylindrical upper portion 82a with a lower portion 82b. The ribbon take-up roll R5 is freely rotatably supported in the take-up roll storage part 82 and rotates in a predetermined rotation direction (direction E of FIG. 2) in a mounted state of the ink ribbon cartridge RK so as to take up the used ink ribbon IB after print formation.

Therefore, the ink ribbon IB fed out from the ribbon feed-out roll R4 is disposed closer to the printing head 11 on the adhesive tape 150 sandwiched between the printing head 11 and the feeding roller 12 and comes into contact with the bottom of the printing head 11. The ink of the ink ribbon IB is heated by the printing head 11 and transferred to the print-receiving layer 154 of the adhesive tape 150, and the used ink ribbon IB is then taken up by the ribbon take-up roll R5.

### <Separation Material Roll and Periphery Thereof>

As shown in FIGS. 2 and 5, the above described coupling arm 16 of the tape cartridge TK includes a peeling portion 17 including a substantially horizontal slit shape, for example. The peeling portion 17 is a portion peeling off the separation material layer 151 from the printed adhesive tape 150′ fed out from the adhesive tape roll R1 toward the front side. By peeling off the separation material layer 151 by the peeling portion 17, the printed adhesive tape 150′ having a print formed as described above is divided into the separation material layer 151 and a printed adhesive tape 150″ made up of the print-receiving layer 154, the base layer 153, and the adhesive layer 152 other than the separation material layer 151.

The tape cartridge TK has a separation material roll R3 formed into a roll shape by sequentially winding the separation material layer 151 peeled off as described above around an outer circumferential portion of a core 29. In particular, when the tape cartridge TK is mounted, the separation material roll R3 is received from above and stored in the above described second storage part 5 with an axis O3 of winding of the printed adhesive tape 150″ defined in the left-right direction. While being stored in the second storage part 5 (while the tape cartridge TK is mounted), the core 29 is driven via the gear mechanism (not shown) by a third motor M3 disposed inside the housing main body 2a to rotate in a predetermined rotation direction (direction C of FIG. 2) in the second storage part 5, thereby taking up the separation material layer 151.

In this case, the above described second bracket portions 21, 21 of the tape cartridge TK sandwich the separation material roll R3 from both the left and right sides along the axis O3, and rotatably hold the core 29 (in other words, the separation material roll R3) while the tape cartridge TK is mounted on the housing main body 2a. These second bracket portions 21, 21 are connected at upper end portions through a second connecting portion 23 extended substantially along the left-right direction. The above described first bracket portions 20, 20 and the first connecting portion 22 on the rear side of the tape cartridge TK are connected to the second bracket portions 21, 21 and the second connecting portion 23 on the front side by a pair of left and right roll-coupling beam portions 24, 24.

It is noted that FIG. 5 shows the state before the separation material roll R3 is formed by winding the separation material layer 151 around the outer circumferential portion of the core 29 (the case of the unused tape cartridge TK). Therefore, FIG. 5 shows substantially circular roll flange portions f3, f4 disposed to sandwich the both sides of the separation material layer 151 in the tape width direction and includes reference numeral “R3” added for convenience at a position where the separation material roll R3 is formed.

### <Printed Adhesive Tape Roll and Periphery Thereof>

On the other hand, as shown in FIGS. 2 and 4, the above described third storage part 4 receives from above a take-up mechanism 40 including a core 41 sequentially winding the printed adhesive tape 150″ into a roll shape. The take-up mechanism 40 is stored with an axis O2 of winding of the printed adhesive tape 150″ defined in the left-right direction such that the above described core 41 is rotatably supported around the axis O2. While the take-up mechanism 40 is stored in the third storage part 4, the core 41 is driven via the gear mechanism (not shown) by a second motor M2 disposed inside the housing main body 2a to rotate in a predetermined rotation direction (direction B of FIG. 2) in the third storage part 4, thereby sequentially taking and piling up the printed adhesive tape 150″ around an outer circumferential portion of the core 41. As a result, the printed adhesive tape 150″ is sequentially wound around the outer circumferential portion of the core 41 into a roll shape, thereby forming a printed adhesive tape roll R2.

### <Cutter Mechanism>

As shown in FIG. 2, a cutter mechanism 30 is disposed downstream of the printing head 11 and upstream of the printed adhesive tape roll R2 along the feeding direction of the adhesive tape 150 (tape feeding direction).

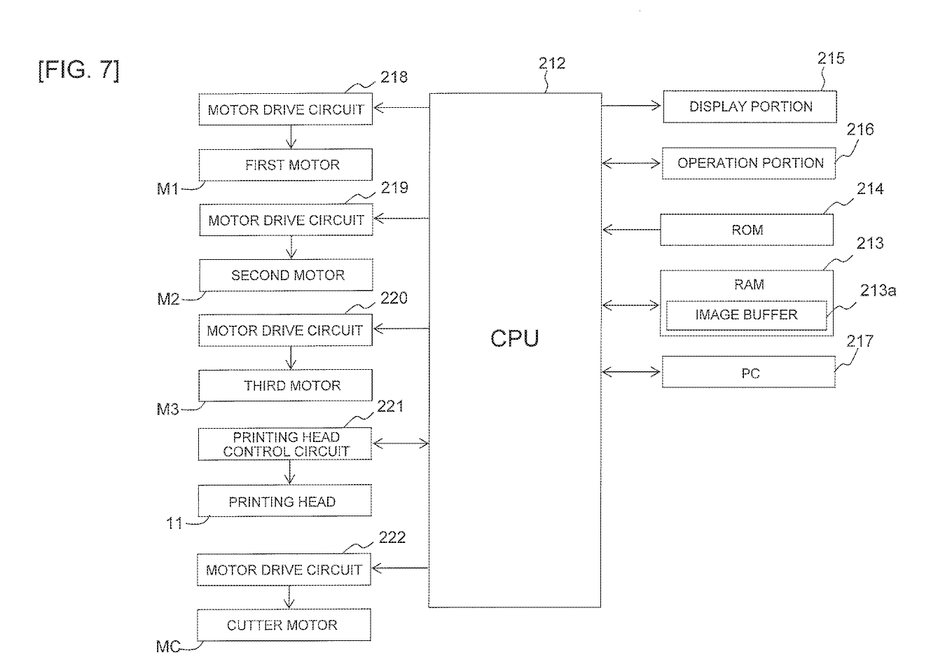

Although not shown in detail, the cutter mechanism 30 has a movable blade, and a running body capable of supporting the movable blade and running in the tape width direction (in other words, left-right direction). The running body is driven by a cutter motor MC (see FIG. 7 described later) to run to move the movable blade in the tape width direction so as to cut the above described printed adhesive tape 150″ in the tape width direction.

### <General Operation of Printer>

A general operation of the printer 1 having the above described configuration will be described.

When the tape cartridge TK is mounted on the first predetermined position 13, the adhesive tape roll R1 is stored in the first storage part 3, and the core 29, the roll flange portions f3, f4, etc., for forming the separation material roll R3 are stored in the second storage part 5. The third storage part 4 stores the take-up mechanism 40 for forming the printed adhesive tape roll R2.

In this state, an operator manually peels off the separation material layer 151 from the adhesive tape 150 and attaches a tip end of the tape made up of the print-receiving layer 154, the base layer 153, and the adhesive layer 152 to the core 41 of the take-up mechanism 40. When the feeding roller 12 is driven, the adhesive tape 150 is fed out by the rotation of the adhesive tape roll R1 stored in the first storage part 3 and is fed toward the front side. On the print-receiving layer 154 of the adhesive tape 150 being fed, the printing head 11 forms the desired print portion 155 to turn the tape into the printed adhesive tape 150′. When the printed adhesive tape 150′ after print formation is further fed toward the front side to the peeling portion 17, the peeling portion 17 peels off the separation material layer 151 to turn the tape into the printed adhesive tape 150″. The peeled separation material layer 151 is fed toward the bottom side and introduced into the second storage part 5 and is wound around the outer circumferential portion of the core 29 in the second storage part 5 to form the separation material roll R3.

On the other hand, the printed adhesive tape 150″ after peel-off of the separation material layer 151 is further fed toward the front side and introduced into the third storage part 4 and is wound around the outer circumferential portion of the core 41 of the take-up mechanism 40 in the third storage part 4 to form the printed adhesive tape roll R2. In this state, the cutter mechanism 30 disposed downstream in the tape feeding direction (i.e., on the front side) cuts the printed adhesive tape 150″. This enables the operator to cut the printed adhesive tape 150″ taken up by the core 41 at desired timing and to take out the printed adhesive tape roll R2 from the third storage part 4 after cutting.

Although not described with reference to the drawings, the printed adhesive tape roll R2 may be formed by winding the printed adhesive tape 150′ including the separation material layer 151 around the outer circumferential portion of the core 41 of the take-up mechanism 40 without peeling off the separation material layer 151 from the printed adhesive tape 150′.

Although not described with reference to the drawings, a tape to be printed without adhesiveness, i.e., non-adhesive tape (tape without the above described adhesive layer 152 and separation material layer 151) may be wound in the roll R1. Also in this case, when the tape cartridge TK is mounted, the roll R1 formed by winding the non-adhesive tape is received from above and stored in the first storage part 3 with the axis O1 of winding of the non-adhesive tape defined in the left-right direction. While being stored in the first storage part 3 (while the tape cartridge TK is mounted), the roll R1 rotates in a predetermined rotation direction (direction A in FIG. 2) in the first storage part 3 to feed out the non-adhesive tape.

In this case, a chute 15 (see FIG. 2) may be disposed for switching the feeding path of the non-adhesive tape (or the above described adhesive tape 150) between a path toward the roll R2 and a path toward a discharging exit (not shown). In particular, by switching the above described feeding path through a switching operation of the chute 15 with a switching lever (not shown), the non-adhesive tape (or the above described printed adhesive tape 150′ or the above described printed adhesive tape 150″) after print formation may directly be discharged without winding in the third storage part 4, to the outside of the housing 2 from a discharging exit (not shown) disposed on the housing 2 on the side of the second openable cover 8b, for example.

### <Control System of Printer>

A control system of the printer 1 will be described with reference to FIG. 7.

As shown in FIG. 7, the printer 1 includes a CPU 212 making up a calculation portion executing a predetermined calculation. The CPU 212 is connected to a RAM 213 and a ROM 214. The CPU 212 executes a signal process in accordance with a program stored in the ROM 214 in advance while using a temporary storage function of the RAM 213, thereby generally controlling the printer 1.

The CPU 212 is also connected to a motor drive circuit 218 carrying out drive control of the above described first motor M1, a motor drive circuit 219 carrying out drive control of the above described second motor M2, a motor drive circuit 220 carrying out drive control of the above described third motor M3, a printing head control circuit 221 carrying out energization control of a heat generation element (not shown) of the above described printing head 11, a motor drive circuit 222 carrying out drive control of the above described cutter motor MC, a display portion 215 performing suitable display, and an operation portion 216 allowing an operator to perform operation and input as needed. Although the CPU 212 is connected to a PC 217 that is an external terminal in this example, the CPU 212 may not be connected to the external terminal if the printer 1 independently operates (as a so-called all-in-one type).

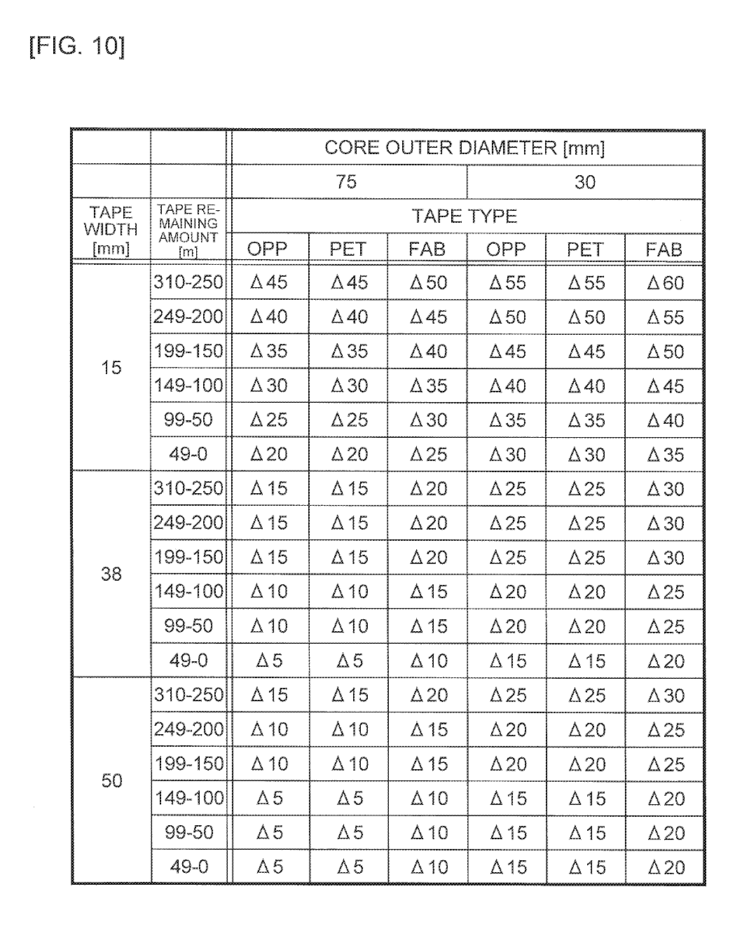

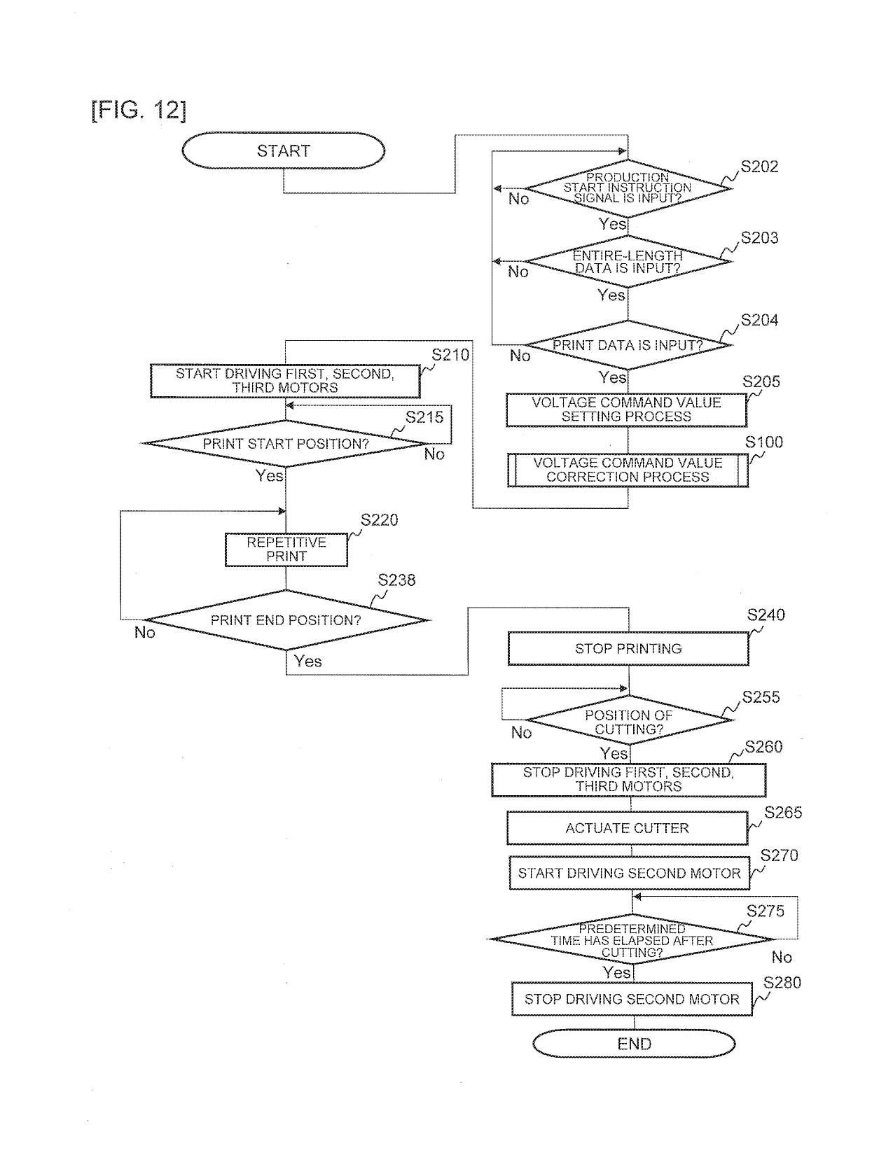

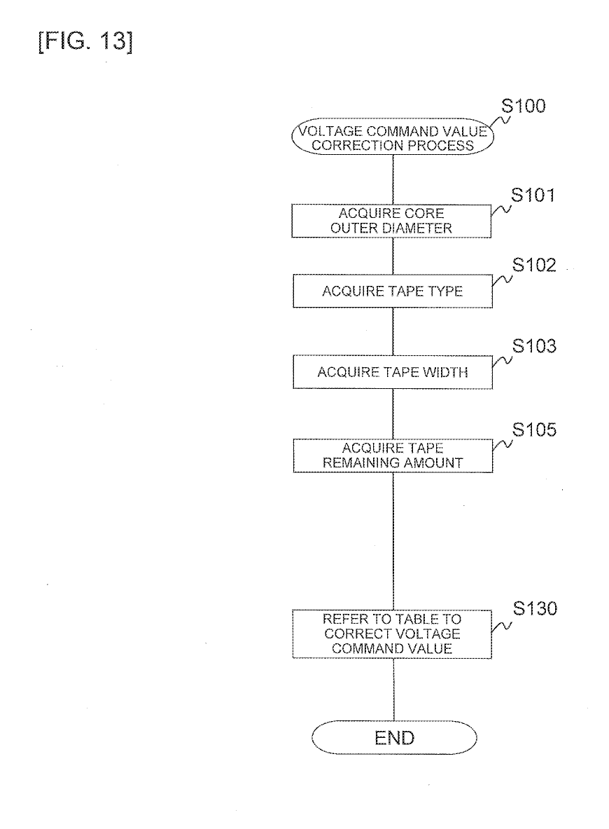

The ROM 214 stores a control program for executing a predetermined control process (including a program executing processes shown in flowcharts of FIGS. 12 and 13 described later). A correction amount table shown in FIG. 10 described later is also stored in the ROM 214.

The RAM 213 includes an image buffer 213a in which, for example, print data generated in accordance with an operation by an operator on the operation portion 216 (or the PC 217) is developed and stored as dot pattern data (one unit print data) for printing in a predetermined print area of the print-receiving layer 154 of the above described adhesive tape 150. Based on the above described control program, the CPU 212 repeatedly prints one image (unit print image) corresponding to the dot pattern data stored in the image buffer 213a on the print-receiving layer 154 of the adhesive tape 150 with the printing head 11 while feeding the adhesive tape 150 with the feeding roller 12.

<Characteristics of this Embodiment>

This embodiment configured as described above is characterized by a technique of preventing an increase in tape feeding speed so as to prevent a deterioration in print quality even if a slip occurs between the feeding roller 12 and the adhesive tape 150 for some reason. Details thereof will hereinafter be described in order.

### <Drive Torque Control>

As described above, the adhesive tape 150 fed out from the adhesive tape roll R1 is fed by the feeding roller 12 driven by the first motor M1. The printing head 11 forms the desired print portion 155 on the print-receiving layer 154 of the adhesive tape 150 at a desired printing speed, thereby generating the printed adhesive tape 150′. Subsequently, the printed adhesive tape 150″ is generated by peeling off the separation material layer 151 from the printed adhesive tape 150′ and is sequentially taken up around the outer circumferential portion of the core 41 driven by the second motor M2 to form the printed adhesive tape roll R2.

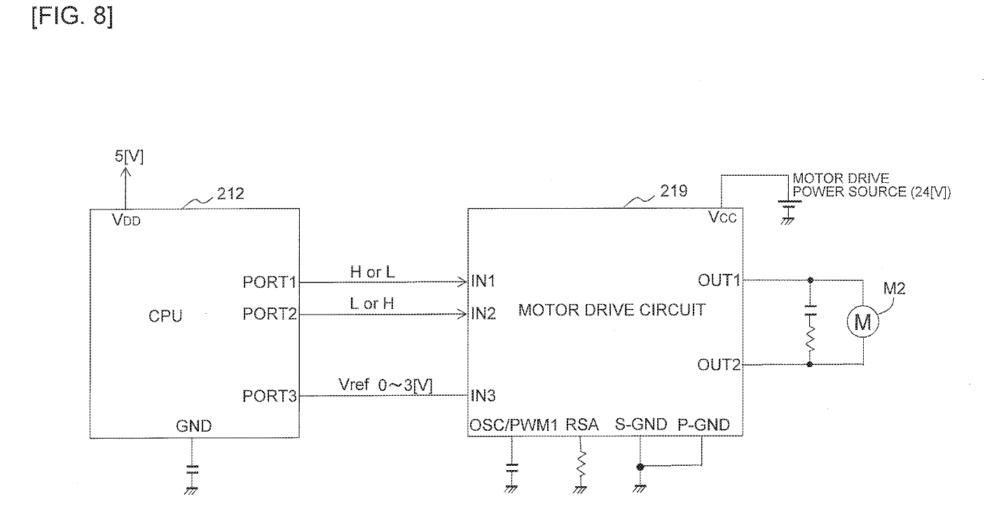

The feeding/taking-up behavior as described above causes forces to act on the adhesive tape 150 both at the time of contact and feeding by the feeding roller 12 and at the time of taking-up by the core 41. In this embodiment, the CPU 212 carries out the drive control of the second motor M2 though the motor drive circuit 219 in accordance with a known technique (in synchronization with the drive control of the printing head 11 through the printing head control circuit 221) such that the tape is smoothly fed and taken up while keeping the balance between these two forces so as to achieve the above described desired printing speed. The drive torque of the second motor M2 in this case is controlled to a predetermined drive torque (hereinafter also referred to as “first drive torque”) (that is a theoretical value) corresponding to the absence of a slip between the feeding roller 12 and the adhesive tape 150. Specifically, the motor drive circuit 219 carries out constant torque control for the second motor M2. This constant torque control will hereinafter be described with reference to FIG. 8.

### <Constant Torque Control>

As shown in FIG. 8, the CPU 212 includes three communication ports PORT1, PORT2, PORT3 and sends respective signals via these communication ports PORT1, PORT2, PORT3 to three input terminals IN1, IN2, IN3 of the motor drive circuit 219.

The motor drive circuit 219 includes two output terminals OUT1, OUT2. The output terminal OUT1 is connected to one polarity of the second motor M2 and the output terminal OUT2 is connected to the other polarity of the second motor M2.

The CPU 212 transmits a high-level signal H or a low-level signal L via the communication port PORT1 to the motor drive circuit 219, and the motor drive circuit 219 inputs the high-level signal H or the low-level signal L via the input terminal IN1. The CPU 212 transmits a high-level signal H or a low-level signal L at the level opposite to the communication port PORT1 via the communication port PORT2 to the motor drive circuit 219, and the motor drive circuit 219 inputs the high-level signal H or the low-level signal L via the input terminal IN2.

For example, when the CPU 212 transmits the high-level signal H via the communication port PORT1 to the motor drive circuit 219 and transmits the low-level signal L via the communication port PORT2 to the motor drive circuit 219, the motor drive circuit 219 inputs the high-level signal H via the input terminal IN1 and inputs the low-level signal L via the input terminal IN2, thereby rotating the second motor M2 in the forward direction.

On the other hand, when the CPU 212 transmits the low-level signal L via the communication port PORT1 to the motor drive circuit 219 and transmits the high-level signal H via the communication port PORT2 to the motor drive circuit 219, the motor drive circuit 219 inputs the low-level signal L via the input terminal IN1 and inputs the high-level signal H via the input terminal IN2, thereby rotating the second motor M2 in the reverse direction.

The CPU 212 transmits a voltage command value Vref set to a voltage (e.g., 0 to 3 [V]) via the communication port PORT3 to the motor drive circuit 219, and the motor drive circuit 219 inputs the voltage command value Vref via the input terminal IN3. This causes the motor drive circuit 219 to carry out the constant torque control of setting the drive torque of the second motor M2 to a constant value corresponding to the input voltage command value Vref.

In this case, the value of the voltage command value Vref input to the motor drive circuit 219 is controlled by the CPU 212 to a predetermined voltage command value (hereinafter also referred to as a “first voltage command value”) corresponding to the above described first drive torque. Therefore, the motor drive circuit 219 carries out the constant torque control such that the drive torque of the second motor M2 is set to a constant value corresponding to the input first voltage command value.

### <Slip Between Feeding Roller and Tape to be Printed>

Even if the constant torque control using the first voltage command value as described above is performed, a slip may occur between the feeding roller 12 and the adhesive tape 150 for some reason.

For example, when a remaining amount of the adhesive tape 150 (a tape remaining amount) in the adhesive tape roll R1 is relatively large, the adhesive tape 150 can be pulled out from the outer diameter side of the adhesive tape roll R1 with relatively small force and, therefore, a slip easily occurs in a tape advance direction (the direction corresponding to the downstream side of the tape feeding direction) relative to the feeding roller 12. For example, if a width of the adhesive tape 150 (a tape width) is relatively narrow, a take-up force of the driven core 41 concentrates on a narrow range of the printed adhesive tape 150″ and, therefore, a slip easily occurs in the tape advance direction relative to the feeding roller 12 in the same way as above. For example, if a type of the adhesive tape 150 (a tape type) is of relatively small friction coefficient such as fabric, a slip easily occurs in the tape advance direction relative to the contacting feeding roller 12. For example, if the outer diameter of the core 41 is relatively small, a tension applied to the printed adhesive tape 150″ is made larger at the time of taking-up by the above described core 41 and, therefore, a slip easily occurs in the tape advance direction relative to the feeding roller 12 in the same way as above.

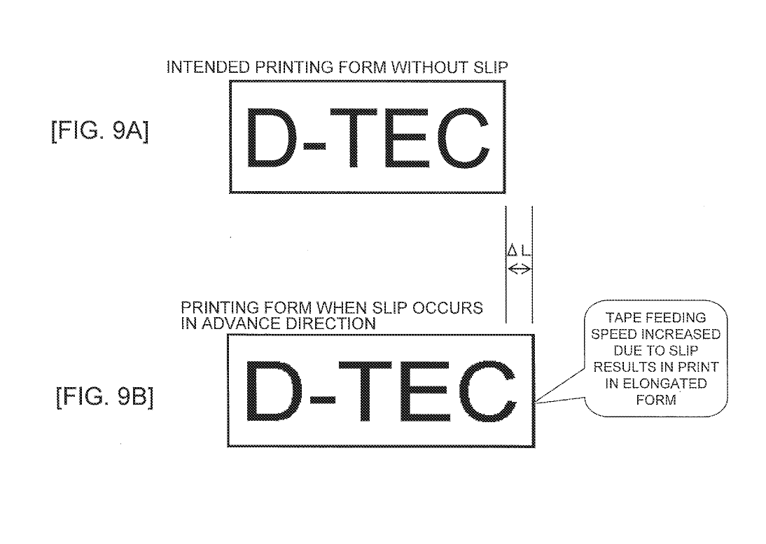

In these cases, the occurrence of the slip in the above described tape advance direction makes the tape feeding speed slightly faster between the printing speed and the tape feeding speed that would otherwise be synchronized with each other. As a result, when the slip occurs in the above described tape advance direction, for example, as shown in FIGS. 9A and 9B for comparison, a print is formed in a form elongated in the tape feeding direction (see FIG. 9B) as compared to an intended form of print formation (see FIG. 9A) and a so-called print length is made longer. In the example shown in FIGS. 9A and 9B, a length of one unit image including a text “D-TEC” is made longer by ΔL.

### <Correction of Voltage Command Value>

In this embodiment, to deal with the possibility of occurrence of a slip in the above described tape advance direction due to the above described reasons during provision of the constant torque control using the first voltage command value described above, the CPU 212 corrects the value of the voltage command value Vref output to the motor drive circuit 219 from the first voltage command value to a voltage command value (hereinafter also referred to as a “second voltage command value”) corresponding to a drive torque of the second motor M2 (hereinafter also referred to as a “second drive torque”) in accordance with the above described tape remaining amount, tape width, tape type, and outer diameter (outer diameter dimension) of the core 41. Specifically, if a slip may occur in the above described tape advance direction, the value of the voltage command value Vref is corrected to the second voltage command value making the drive torque of the second motor M2 smaller as compared to the first voltage command value.

### <Correction Amount Table>

In this embodiment, to acquire a correction amount of the first voltage command value at the time of the above described correction, the above described ROM 214 stores a correction amount table indicative of a correction amount of the first voltage command value corresponding to a combination of the above described tape remaining amount, tape width, tape type, and outer diameter of the core 41. FIG. 10 shows an example of the correction amount table.

In the example shown in FIG. 10, it is assumed that the entire length of the adhesive tape 150 in the unused adhesive tape roll R1 (i.e., the maximum value of the tape remaining amount) is 310 [m], and the tape remaining amount is divided into six stages, i.e., a stage of 310 [m] or less and 250 [m] or more (described as “310-250” for simplicity in FIG. 10), a stage of less than 250 [m] and not less than 200 [m] (described as “249-200” for simplicity in FIG. 10), a stage of less than 200 [m] and not less than 150 [m] (described as “199-150” for simplicity in FIG. 10), a stage of less than 150 [m] and not less than 100 [m] (described as “149-100” for simplicity in FIG. 10), a stage of less than 100 [m] and not less than 50 [m] (described as “99-50” for simplicity in FIG. 10), and a stage of less than 50 [m] and not less than 0 [m] (described as “49-0” for simplicity in FIG. 10). The tape width is categorized into three types of 15 [mm], 38 [mm], and 50 [mm] The three tape types are defined as an OPP material (oriented polypropylene; described as “OPP” in FIG. 10), a PET material (polyethylene terephthalate; described as “PET” in FIG. 10), and a fabric material (described as “FAB” in FIG. 10). The outer diameter of the core 41 (described as “core outer diameter” in FIG. 10) is categorized into two types of 75 [mm] and 30 [mm] The correction amount (in [%]; in FIG. 10, “A” is added to an amount having a negative value) of the first voltage command value is determined in accordance with a combination of the tape remaining amount, the tape width, the tape type, and the outer diameter of the core 41.

For example, in the case of the tape width of 15 [mm], the tape type of the OPP material, and the outer diameter of the core 41 of 75 [mm], the correction amount is Δ45 [%] if the tape remaining amount is 310 [m] or less and 250 [m] or more; the correction amount is Δ40 [%] if the tape remaining amount is less than 250 [m] and not less than 200 [m]; the correction amount is Δ35 [%] if the tape remaining amount is less than 200 [m] and not less than 150 [m]; the correction amount is Δ30 [%] if the tape remaining amount is less than 150 [m] and not less than 100 [m]; the correction amount is Δ25 [%] if the tape remaining amount is less than 100 [m] and not less than 50 [m]; and the correction amount is Δ20 [%] if the tape remaining amount is less than 50 [m] and not less than 0 [m].

For example, in the case of the tape width of 50 [mm], the tape type of the OPP material, and the outer diameter of the core 41 of 75 [mm], the correction amount is Δ15 [%] if the tape remaining amount is 310 [m] or less and 250 [m] or more; the correction amount is Δ10 [%] if the tape remaining amount is less than 250 [m] and not less than 200 [m]; the correction amount is Δ10 [%] if the tape remaining amount is less than 200 [m] and not less than 150 [m]; the correction amount is Δ5 [%] if the tape remaining amount is less than 150 [m] and not less than 100 [m]; the correction amount is Δ5 [%] if the tape remaining amount is less than 100 [m] and not less than 50 [m]; and the correction amount is Δ5 [%] if the tape remaining amount is less than 50 [m] and not less than 0 [m].

For example, in the case of the tape width of 15 [mm], the tape type of the fabric material, and the outer diameter of the core 41 of 75 [mm], the correction amount is Δ50 [%] if the tape remaining amount is 310 [m] or less and 250 [m] or more; the correction amount is Δ45 [%] if the tape remaining amount is less than 250 [m] and not less than 200 [m]; the correction amount is Δ40 [%] if the tape remaining amount is less than 200 [m] and not less than 150 [m]; the correction amount is Δ35 [%] if the tape remaining amount is less than 150 [m] and not less than 100 [m]; the correction amount is Δ30 [%] if the tape remaining amount is less than 100 [m] and not less than 50 [m]; and the correction amount is Δ25 [%] if the tape remaining amount is less than 50 [m] and not less than 0 [m].

For example, in the case of the tape width of 15 [mm], the tape type of the OPP material, and the outer diameter of the core 41 of 30 [mm], the correction amount is Δ55 [%] if the tape remaining amount is 310 [m] or less and 250 [m] or more; the correction amount is Δ50 [%] if the tape remaining amount is less than 250 [m] and not less than 200 [m]; the correction amount is Δ45 [%] if the tape remaining amount is less than 200 [m] and not less than 150 [m]; the correction amount is Δ40 [%] if the tape remaining amount is less than 150 [m] and not less than 100 [m]; the correction amount is Δ35 [%] if the tape remaining amount is less than 100 [m] and not less than 50 [m]; and the correction amount is Δ30 [%] if the tape remaining amount is less than 50 [m] and not less than 0 [m].

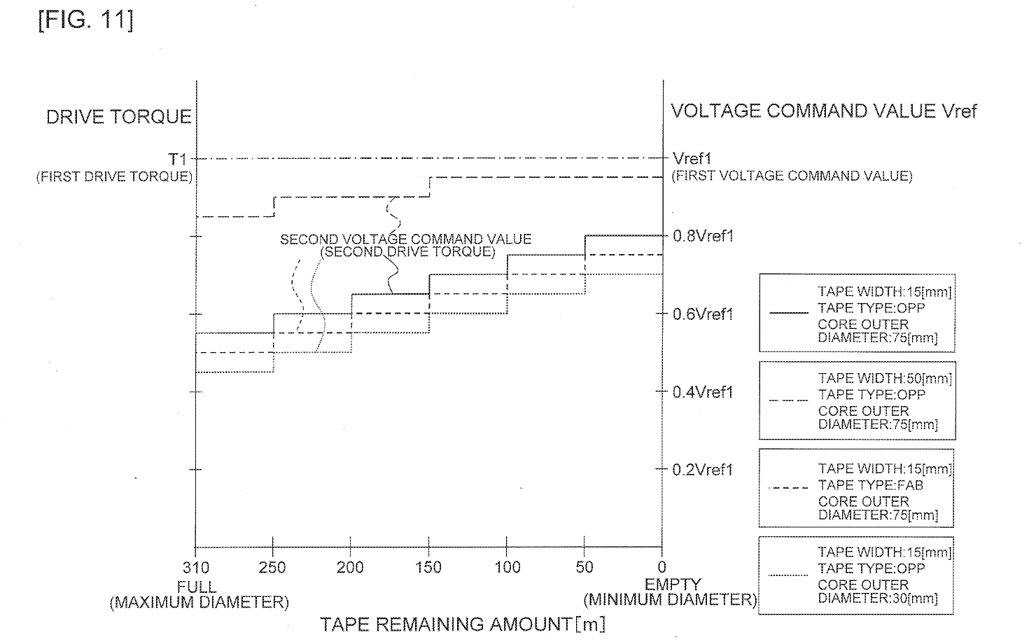

An example of the correction technique for the first voltage command value using the above described correction amount table will hereinafter be described with reference to FIG. 11. FIG. 11 shows graphed relationships of the tape remaining amount, the drive torque of the second motor M2, and the voltage command value Vref in the case of the tape width of 15 [mm], the tape type of the OPP material, and the outer diameter of the core 41 of 75 [mm]; in the case of the tape width of 50 [mm], the tape type of the OPP material, and the outer diameter of the core 41 of 75 [mm]; in the case of the tape width of 15 [mm], the tape type of the fabric material, and the outer diameter of the core 41 of 75 [mm]; and in the case of the tape width of 15 [mm], the tape type of the OPP material, and the outer diameter of the core 41 of 30 [mm] In FIG. 11, T1 denotes the first drive torque and Vref1 denotes the first voltage command value corresponding to the first drive torque T1.

As shown in FIG. 11, in the case of the tape width of 15 [mm], the tape type of the OPP material, and the outer diameter of the core 41 of 75 [mm], if the tape remaining amount is 310 [m] or less and 250 [m] or more, the correction amount is Δ45 [%] and the first voltage command value Vref1 is therefore reduced by 45 [%] to set 0.55Vref1 as the second voltage command value. If the tape remaining amount is less than 250 [m] and not less than 200 [m], the correction amount is Δ40 [%] and the first voltage command value Vref1 is therefore reduced by 40 [%] to set 0.6Vref1 as the second voltage command value. If the tape remaining amount is less than 200 [m] and not less than 150 [m], the correction amount is Δ35 [%] and the first voltage command value Vref1 is therefore reduced by 35 [%] to set 0.65Vref1 as the second voltage command value. If the tape remaining amount is less than 150 [m] and not less than 100 [m], the correction amount is Δ30 [%] and the first voltage command value Vref1 is therefore reduced by 30 [%] to set 0.7Vref1 as the second voltage command value. If the tape remaining amount is less than 100 [m] and not less than 50 [m], the correction amount is Δ25 [%] and the first voltage command value Vref1 is therefore reduced by 25 [%] to set 0.75Vref1 as the second voltage command value. If the tape remaining amount is less than 50 [m] and not less than 0 [m], the correction amount is Δ20 [%] and the first voltage command value Vref1 is therefore reduced by 20 [%] to set 0.8Vref1 as the second voltage command value.

Similarly, in the case of the tape width of 50 [mm], the tape type of the OPP material, and the outer diameter of the core 41 of 75 [mm], if the tape remaining amount is 310 [m] or less and 250 [m] or more, the correction amount is Δ15 [%] and the first voltage command value Vref1 is therefore reduced by 15 [%] to set 0.85Vref1 as the second voltage command value. If the tape remaining amount is less than 250 [m] and not less than 200 [m] or is less than 200 [m] and not less than 150 [m], the correction amount is Δ10 [%] and the first voltage command value Vref1 is therefore reduced by 10 [%] to set 0.9Vref1 as the second voltage command value. If the tape remaining amount is less than 150 [m] and not less than 100 [m], is less than 100 [m] and not less than 50 [m], or is less than 50 [m] and not less than 0 [m], the correction amount is Δ5 [%] and the first voltage command value Vref1 is reduced by 5 [%] to set 0.95Vref1 as the second voltage command value.

Similarly, in the case of the tape width of 15 [mm], the tape type of the fabric material, and the outer diameter of the core 41 of 75 [mm], if the tape remaining amount is 310 [m] or less and 250 [m] or more, the correction amount is Δ50 [%] and the first voltage command value Vref1 is therefore reduced by 50 [%] to set 0.5Vref1 as the second voltage command value. If the tape remaining amount is less than 250 [m] and not less than 200 [m], the correction amount is Δ45 [%] and the first voltage command value Vref1 is therefore reduced by 45 [%] to set 0.55Vref1 as the second voltage command value. If the tape remaining amount is less than 200 [m] and not less than 150 [m], the correction amount is Δ40 [%] and the first voltage command value Vref1 is therefore reduced by 40 [%] to set 0.6Vref1 as the second voltage command value. If the tape remaining amount is less than 150 [m] and not less than 100 [m], the correction amount is Δ35 [%] and the first voltage command value Vref1 is therefore reduced by 35 [%] to set 0.65Vref1 as the second voltage command value. If the tape remaining amount is less than 100 [m] and not less than 50 [m], the correction amount is Δ30 [%] and the first voltage command value Vref1 is therefore reduced by 30 [%] to set 0.7Vref1 as the second voltage command value. If the tape remaining amount is less than 50 [m] and not less than 0 [m], the correction amount is Δ25 [%] and the first voltage command value Vref1 is therefore reduced by 25 [%] to set 0.75Vref1 as the second voltage command value.

Similarly, in the case of the tape width of 15 [mm], the tape type of the OPP material, and the outer diameter of the core 41 of 30 [mm], if the tape remaining amount is 310 [m] or less and 250 [m] or more, the correction amount is Δ55 [%] and the first voltage command value Vref1 is therefore reduced by 55 [%] to set 0.45Vref1 as the second voltage command value. If the tape remaining amount is less than 250 [m] and not less than 200 [m], the correction amount is Δ50 [%] and the first voltage command value Vref1 is therefore reduced by 50 [%] to set 0.5Vref1 as the second voltage command value. If the tape remaining amount is less than 200 [m] and not less than 150 [m], the correction amount is Δ45 [%] and the first voltage command value Vref1 is therefore reduced by 45 [%] to set 0.55Vref1 as the second voltage command value. If the tape remaining amount is less than 150 [m] and not less than 100 [m], the correction amount is Δ40 [%] and the first voltage command value Vref1 is therefore reduced by 40 [%] to set 0.6Vref1 as the second voltage command value. If the tape remaining amount is less than 100 [m] and not less than 50 [m], the correction amount is Δ35 [%] and the first voltage command value Vref1 is therefore reduced by 35 [%] to set 0.65Vref1 as the second voltage command value. If the tape remaining amount is less than 50 [m] and not less than 0 [m], the correction amount is Δ30 [%] and the first voltage command value Vref1 is therefore reduced by 30 [%] to set 0.7Vref1 as the second voltage command value.

As can be understood by comparing the cases that the conditions other than the tape width are equivalent, for example, by comparing the case of the tape width of 15 [mm], the tape type of the OPP material, and the outer diameter of the core 41 of 75 [mm] with the case of the tape width of 50 [mm], the tape type of the OPP material, and the outer diameter of the core 41 of 75 [mm], the correction is made such that the second voltage command value becomes smaller (in other words, the correction amount of the first voltage command value becomes lager) in the case of the tape width of 15 [mm] as compared to the case of the tape width of 50 [mm].

As can be understood by comparing the cases that the conditions other than the tape type are equivalent, for example, by comparing the case of the tape width of 15 [mm], the tape type of the OPP material, and the outer diameter of the core 41 of 75 [mm] with the case of the tape width of 15 [mm], the tape type of the fabric material, and the outer diameter of the core 41 of 75 [mm], the correction is made such that the second voltage command value becomes smaller (in other words, the correction amount of the first voltage command value becomes lager) in the case of the tape type of the fabric material as compared to the case of the tape type of the OPP material.

As can be understood by comparing the cases that the conditions other than the outer diameter of the core 41 are equivalent, for example, by comparing the case of the tape width of 15 [mm], the tape type of the OPP material, and the outer diameter of the core 41 of 75 [mm] with the case of the tape width of 15 [mm], the tape type of the OPP material, and the outer diameter of the core 41 of 30 [mm], the correction is made such that the second voltage command value becomes smaller (in other words, the correction amount of the first voltage command value becomes lager) in the case of the outer diameter of the core 41 of 30 [mm] as compared to the case of the outer diameter of the core 41 of 75 [mm].

As can be understood by comparing the stages of the tape remaining amount with each other when the tape width, the outer diameter of the core 41, and the tape type are equivalent, for example, in the case of the tape width of 15 [mm], the tape type of the OPP material, and the outer diameter of the core 41 of 75 [mm], the correction is made such that the second voltage command value becomes smaller (in other words, the correction amount of the first voltage command value becomes lager) in the stages of larger tape remaining amount as compared to the stages of smaller tape remaining amount.

### <Constant Torque Control Using Second Voltage Command Value>

The CPU 212 outputs the above described second voltage command value after the correction (smaller than the above described first voltage command value) to the motor drive circuit 219, and the motor drive circuit 219 carries out the constant torque control such that the drive torque of the second motor M2 is set to a constant value corresponding to the input second voltage command value. As a result, an increase in the above described tape feeding speed can be prevented.

### <Control Flow>

Details of the process executed by the CPU 212 for implementing the technique described above will hereinafter be described with reference to FIG. 12.

In FIG. 12, for example, an operator powers on the printer 1 and the process shown in the flowchart of FIG. 12 is started (“START” position).

At step S202, the CPU 212 determines whether a production start instruction signal for the printed adhesive tape 150″ is input in accordance with a production start operation for the printed adhesive tape 150″ by the operator on the operation portion 216 (or the PC 217). If the production start instruction signal is not input, the determination at step S202 is negative (S202:NO) and the CPU 212 waits in a loop. If the production start instruction signal is input, the determination at step S202 is affirmative (S202:YES) and the CPU 212 goes to step S203.

At step S203, the CPU 212 determines whether entire-length data is input that represents the entire length of the printed adhesive tape 150″ to be produced along the tape feeding direction, in accordance with an operation by the operator on the operation portion 216 (or the PC 217). If the entire-length data is not input, the determination at step S203 is negative (S203:NO), the CPU 212 returns to above described step S202 to repeat the same procedure. If the entire-length data is input, the determination at step S203 is affirmative (S203:YES) and the CPU 212 goes to step S204.

At step S204, the CPU 212 determines whether the above described one unit print data for repeatedly forming a print on the adhesive tape 150 is input based on an operation by the operator on the operation portion 216 (or the PC 217). If the unit print data is not input, the determination at step S204 is negative (S204:NO) and the CPU 212 returns to above described step S202 to repeat the same procedure. If the unit print data is input, the determination at step S204 is affirmative (S204:YES) and the CPU 212 goes to step S205.

At step S205, the CPU 212 executes a voltage command value setting process to set the voltage command value Vref for the above described motor drive circuit 219 with a known technique (in synchronization with the drive control of the printing head 11) so as to achieve a desired printing speed set in advance. The voltage command value Vref in this case is set to the above described first voltage command value corresponding to the absence of a slip between the feeding roller 12 and the adhesive tape 150. Although not described in detail, the voltage command value Vref for the above described motor drive circuit 218 and the voltage command value Vref for the above described motor drive circuit 220 are also set in accordance with the voltage command value Vref for the motor drive circuit 219 set in this way. Subsequently, the CPU 212 goes to step S100.

At step S100, the CPU 212 executes the voltage command value correction process (see FIG. 13 described later for details) to correct a value of the voltage command value Vref output to the above described motor drive circuit 219 from the first voltage command value set at above described step S205 to the above described second voltage command value.

### <Voltage Command Value Correction Process>

A detailed procedure of the voltage command value correction process of above described step S100 will hereinafter be described with reference to FIG. 13.

In FIG. 13, at step S101, the CPU 212 acquires information on the outer diameter of the above described core 41 (the outer diameter information of the core 41). In this case, the outer diameter information of the core 41 may be acquired by detecting a type of the mounted take-up mechanism 40 with a suitable sensor or may be acquired based on a result of operation input by the operator on the operation portion 216 (or the PC 217).

Subsequently, at step S102, the CPU 212 acquires information on the above described tape type (the tape type information). In this case, the tape type information may be acquired by detecting a type of the mounted tape cartridge TK with a suitable sensor or may be acquired based on a result of operation input by the operator on the operation portion 216 (or the PC 217).

At step S103, the CPU 212 acquires information on the above described tape width (the tape width information). As is the case with the above description, the tape width information may be acquired by detecting a type of the mounted tape cartridge TK with a suitable sensor or may be acquired based on a result of operation input by the operator on the operation portion 216 (or the PC 217).

Subsequently, at step S105, the CPU 212 acquires information on the above described tape remaining amount (the tape remaining amount information). In this case, the tape remaining amount information may be acquired by a suitable known technique, for example, by detecting an outer diameter dimension of the adhesive tape roll R1 with a suitable sensor and calculating the remaining amount based on the detection result, or by detecting a rotation speed after start of a print formation operation with a suitable rotation detection apparatus such as an optical encoder and calculating the remaining amount based on the detection result. Alternatively, the tape remaining amount information stored in a storage medium disposed on the tape cartridge TK may be acquired through wired or wireless communication. Moreover, the tape remaining amount information may be acquired based on a result of operation input by the operator on the operation portion 216 (or the PC 217).

Subsequently, at step S130, the CPU 212 refers to the correction amount table shown in FIG. 10 described above to extract a correction amount in accordance with a combination of the outer diameter information of the core 41 acquired at above described step S101, the tape type information acquired at above described step S102, the tape width information acquired at above described step S103, and the tape remaining amount information acquired at above described step S105. The CPU 212 uses the extracted correction amount to correct the first voltage command value set at above described step S205 to the above described second voltage command value. The CPU 212 then terminates the process of this routine and goes to step S210.

As described in FIG. 12, at step S210, the CPU 212 outputs a control signal (i.e., the voltage command value Vref set/corrected at above described steps S205 and S210) to the motor drive circuits 218, 219, 220 to start driving the first motor M1, the adhesive take-up (described as “AD” in the figure) motor M2, and the third motor M3. Particularly, the drive control of the second motor M2 is performed by the motor drive circuit 219 to which the second voltage command value corrected at above described step S100 is input, such that the drive torque is set to a constant value corresponding to the second voltage command value. This leads to the start of feeding of the above described adhesive tape 150, the printed adhesive tape 150′, and the printed adhesive tape 150″ (hereinafter also simply referred to as “tape feeding”) and taking-up of the above described printed adhesive tape 150″.

At step S215, the CPU 212 determines with a known technique whether the tape feeding reaches a state in which the printing head 11 faces a print start position, based on the unit print data input at above described step S204. If the print start position is not reached, the determination at step S215 is negative (S215:NO) and the CPU 212 waits in a loop. If the print start position is reached, the determination at step S215 is affirmative (S215:YES) and the CPU 212 goes to step S220.

At step S220, the CPU 212 outputs a control signal to the printing head control circuit 221 to energize the heat generation element of the printing head 11, thereby starting repetitive print formation of the unit print image corresponding to the unit print data input at above described step S204 on the adhesive tape 150. Subsequently, the CPU 212 goes to step S238.

At step S238, the CPU 212 determines with a known technique whether the tape feeding reaches a state in which the printing head 11 faces a print end position, based on the unit print data input at above described step S204. If the print end position is not reached, the determination at step S238 is negative (S238:NO) and the CPU 212 returns to above described step S220 to repeat the same procedure. As a result, the repetitive print formation is continued. If the print end position is reached, the determination at step S238 is affirmative (S238:YES) and the CPU goes to step S240.

At step S240, the CPU 212 outputs a control signal to the printing head control circuit 221 to stop energizing the heat generation element of the printing head 11, thereby terminating the print formation on the adhesive tape 150. In this state, the tape feeding is continuously performed. As a result, the subsequent printed adhesive tape 150′ becomes blank without a print. Subsequently, the CPU 212 goes to step S255.

At step S255, the CPU 212 determines whether the tape feeding reaches a position of cutting by the cutter mechanism 30 corresponding to the entire-length data input at above described step S203 (a position of cutting at which the entire length in the tape feeding direction of the printed adhesive tape 150″ wound as the printed adhesive tape roll R2 reaches the length intended by the operator). If the position of cutting is not reached, the determination at step S255 is negative (S255:NO) and the CPU 212 waits in a loop. If the position of cutting is reached, the determination at step S255 is affirmative (S255:YES) and the CPU 212 goes to step S260.

At step S260, the CPU 212 outputs a control signal to the motor drive circuits 218, 219, 220 to stop driving the first motor M1, the second motor M2, and the third motor M3. As a result, the tape feeding is stopped.

Subsequently, at step S265, the CPU 212 outputs a control signal to the motor drive circuit 222 to drive the cutter motor MC, thereby actuating the cutter mechanism 30 to cut the printed adhesive tape 150″.

At step S270, the CPU 212 outputs a control signal to the motor drive circuit 219 to start driving the second motor M2, thereby taking up the printed adhesive tape 150″ around the outer circumferential portion of the core 41 of the take-up mechanism 40.

Subsequently, at step S275, the CPU 212 determines whether a predetermined time has elapsed from the cutting operation of the cutter mechanism 30 at above described step S265. If the predetermined time has not elapsed, the determination at step S275 is negative (S275:NO) and the CPU 212 waits in a loop. This predetermined time may be a time required for taking up the printed adhesive tape 150″ around the outer circumferential portion of the above described core 41. If the predetermined time has elapsed, the determination at step S275 is affirmative (S275:YES) and the CPU 212 goes to step S280.

At step S280, the CPU 212 outputs a control signal to the motor drive circuit 219 to stop driving the second motor M2. As a result, the printed adhesive tape 150″ generated by the above described cutting can reliably be taken up around the outer circumferential portion of the above described core 41. The CPU 212 then terminates the process of this flowchart.

<Effects of this Embodiment>

As described above, in this embodiment, the CPU 212 corrects the drive torque of the second motor M2 in accordance with the tape remaining amount from the first drive torque to the second drive torque (in the above described example, to the second drive torque smaller than the first drive torque). Therefore, an increase in the tape feeding speed can be prevented even if a slip may otherwise occur in the tape advance direction as described above. As a result, the print formation can be prevented from being in the elongated form described above (see FIG. 9B) that may be generated due to an increase in the tape feeding speed, and the print can be formed in the correct form.

Particularly, in this embodiment, the CPU 212 corrects the drive torque of the second motor M2 from the first drive torque to the second drive torque in accordance with the tape width, the tape type, and the outer diameter of the core 41. Therefore, an increase in the tape feeding speed can reliably be prevented so that the print formation can be performed in the correct form.

Particularly, in this embodiment, the CPU 212 corrects the voltage command value Vref output to the motor drive circuit 219 carrying out the constant torque control, in accordance with all of the tape remaining amount, the tape width, the tape type, and the outer diameter of the core 41, from the first voltage command value corresponding to the first drive torque to the second voltage command value corresponding to the second drive torque (in the above described example, to the second voltage command value making the drive torque of the second motor M2 smaller as compared to the first voltage command value). The motor drive circuit 219 carries out the constant torque control to set the drive torque of the second motor M2 to a constant value corresponding to the input second voltage command value. Therefore, an increase in the tape feeding speed can be prevented even if a slip may otherwise occur in the tape advance direction as described above, and the print formation can be performed in the correct form. Since the first voltage command value is finely and accurately corrected in accordance with all of the tape remaining amount, the tape width, the tape type, and the outer diameter of the core 41, the slip can reliably be prevented from occurring.

Particularly, in this embodiment, the CPU 212 refers to the correction amount table (see FIG. 10) indicative of the correction amount corresponding to a combination of the tape remaining amount, the tape width, the tape type, and the outer diameter of the core 41 to correct the first voltage command value to the second voltage command value. In other words, the correction amounts of various cases calculated in advance are stored and used as a table and, therefore, the correction can quickly and reliably be made in a simple process without executing a complicated process. For example, even if the number of the tape types etc. increases in the future and results in an addition of a new parameter or an expansion in value range of parameters for correction amount calculation (in the above described example, the tape remaining amount, the tape width, the tape type, and the outer diameter of the core 41), this can easily be addressed by simply supplementing or updating the data of the table.

Particularly, in this embodiment, the cutter mechanism 30 cuts the printed adhesive tape 150″ taken up by the core 41 to produce the printed adhesive tape roll R2. Therefore, the above described slip can be prevented from occurring in the printer 1 cutting the printed adhesive tape 150″ to produce the printed adhesive tape roll R2 so as to prevent a deterioration in printing quality of the printed adhesive tape roll R2.

The present disclosure is not limited to the above described embodiment and may variously be modified without departing from the spirit and the technical ideas thereof. Such modification examples will hereinafter be described.

### (1) Simplified Setting Mode of Correction Amount

In the above described embodiment, the first voltage command value is corrected by using the correction amount corresponding to a combination of all of the tape remaining amount, the tape width, the tape type, and the outer diameter of the core 41; however, this is not a limitation. In particular, the correction amount may be set in accordance with one or more selected from the tape remaining amount, the tape width, the tape type, and the outer diameter of the core 41 such that at least the tape remaining amount is included.

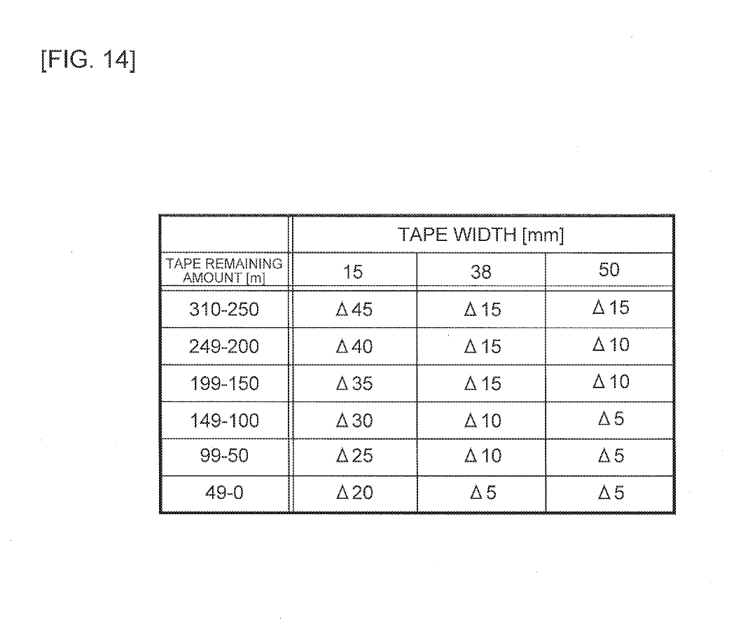

For example, FIG. 14 shows an example of the correction amount table indicative of a correction amount corresponding to a combination of the tape remaining amount and the tape width. In the example shown in FIG. 14, the tape remaining amount is divided into six stages as is the case with FIG. 10 described above while the tape width is classified into three types as is the case with FIG. 10 described above, and the correction amount of the first voltage command value is determined in accordance with the combination of the tape remaining amount and tape width.

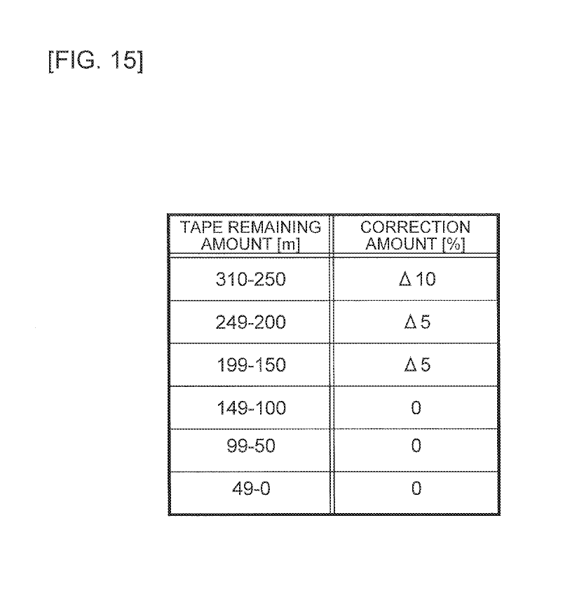

Alternatively, for example, FIG. 15 shows an example of the correction amount table indicative of a correction amount corresponding only to the tape remaining amount. In the example shown in FIG. 15, the tape remaining amount is divided into six stages as is the case with FIG. 10, and the correction amount of the first voltage command value is determined only in accordance with the tape remaining amount.

According to this modification example, the first voltage command value can be corrected in accordance with at least the tape remaining amount to prevent an increase in the tape feeding speed as is the case with the above described embodiment.

(2) Calculation of Correction Amount without Using Correction Amount Table

The correction amount may be calculated in calculation using a predefined calculation formula parameter instead of referring to the correction amount table to extract the correction amount as in the above described embodiment and the modification example of (1).

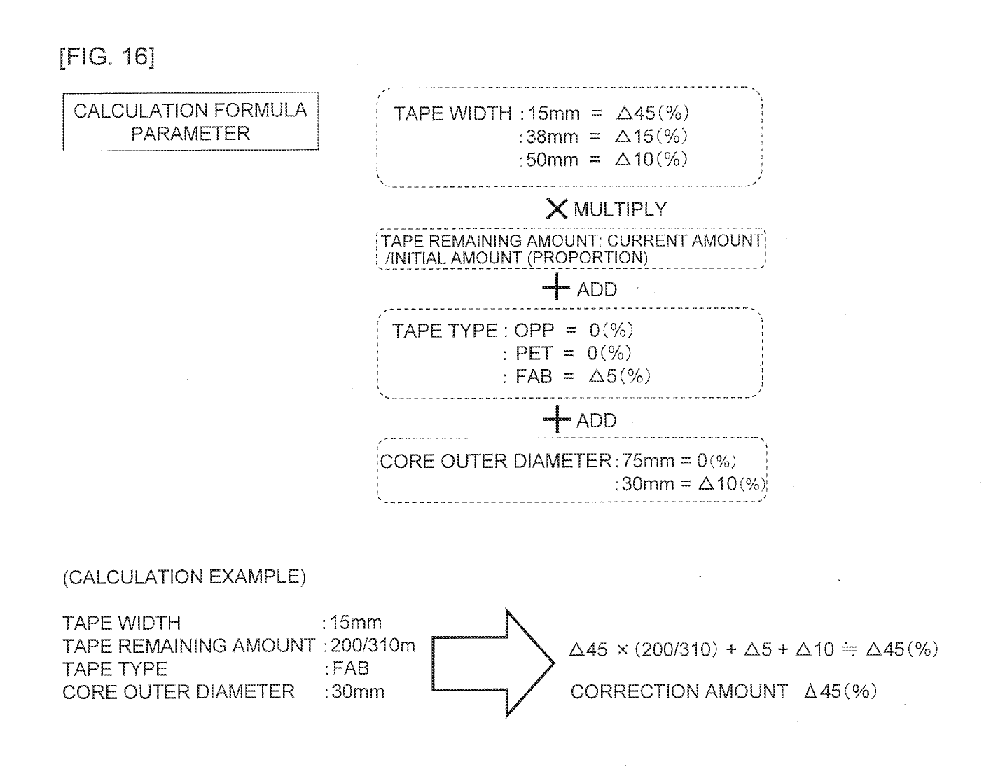

FIG. 16 shows an example of a correction amount calculation technique based on calculation using a calculation formula parameter.

In the example shown in FIG. 16, a value of a predetermined calculation formula parameter (hereinafter also simply referred to as “parameter”) is quantitatively correlated with each of the above described “tape width,” “tape remaining amount,” “tape type,” and “outer diameter of the core 41 (described as “core outer diameter” in FIG. 16).”

In particular, the tape width of 15 [mm] is correlated with a parameter Δ45 [%]; the tape width of 38 [mm] is correlated with a parameter Δ15 [%]; and the tape width of 50 [mm] is correlated with a parameter Δ10 [%].

The tape remaining amount is correlated with a value of “current tape remaining amount/initial (print start time) tape remaining amount” used as a parameter.

The tape type of the OPP material (described as “OPP” in FIG. 16) is correlated with a parameter 0 [%]; the tape type of the PET material (described as “PET” in FIG. 16) is correlated with a parameter 0 [%]; the tape width of the fabric material (described as “FAB” in FIG. 16) is correlated with a parameter Δ5 [%].

The outer diameter of the core 41 of 75 [mm] is correlated with a parameter 0 [%]; the outer diameter of the core 41 of 30 [mm] is correlated with a parameter Δ10 [%].

When the correction amount of the first voltage command value is obtained, the parameter value of “tape width” is multiplied by the parameter value of “tape remaining amount,” and the parameter values of “tape type” and “outer diameter of the core 41” are added for the calculation. The shown example includes the tape width of 15 [mm] (correlated with the parameter value of Δ45 [%]), the tape remaining amount of 200 [m] (correlated with the parameter value of 200/310), the tape type of the fabric material (correlated with the parameter value of Δ5 [%]), and the outer diameter of the core 41 of 30 [mm] (correlated with the parameter value of Δ10 [%]) and, as a result, the correction amount of Δ45×(200/310)+Δ5+Δ10≈Δ45 [%] is finally obtained.

The technique of this modification example provides the same effects as the above described embodiment.

(3) Correction with Ambient Temperature Taken into Account

The first voltage command value may be corrected in accordance with the ambient temperature around the printer 1 in addition to the above described tape remaining amount, the tape width, the tape type, and the outer diameter of the core 41.

For example, if an ambient temperature is relatively high, a mechanical load is reduced during operation and, therefore, a slip tends to occur in the above described tape advance direction.

In this modification example, the CPU 212 is connected to an ambient temperature sensor detecting the ambient temperature around the printer 1 although not shown, and the ROM 214 stores the correction amount table indicative of a correction amount of the first voltage command value corresponding to a combination of the above described tape remaining amount, the tape width, the tape type, the outer diameter of the core 41, and the ambient temperature.

The CPU 212 refers to the above described correction amount table to extract a correction amount in accordance with a combination of the acquired tape remaining amount information, the acquired tape width information, the acquired tape type information, the acquired outer diameter information of the core 41, and information on ambient temperature (ambient temperature information) acquired from the above described ambient temperature sensor, and uses the extracted correction amount to correct the first voltage command value to the second voltage command value.

According to this modification example, the CPU 212 corrects the first voltage command value to the second voltage command value with the ambient temperature taken into account. Therefore, the slip can more reliably be prevented from occurring in the above described tape advance direction.

In the above described example, the first voltage command value is corrected by using the correction amount corresponding to a combination of all of the tape remaining amount, the tape width, the tape type, the outer diameter of the core 41, and the ambient temperature; however, the correction amount may be set in accordance with one or more selected from the tape remaining amount, the tape width, the tape type, and the outer diameter of the core 41 such that at least the tape remaining amount is included, and the ambient temperature (or may be calculated based on calculation as in the above described modification example of (2)).

### (4) When Slip Occurs in Tape Delay Direction

Although the present disclosure has been described by taking as an example the case of a slip occurring in the tape advance direction between the feeding roller 12 and the adhesive tape 150, this is not a limitation and, conversely, a slip may occur in the tape delay direction between the feeding roller 12 and the adhesive tape 150.

For example, when the tape remaining amount is relatively small, a relatively large force is required for pulling out the adhesive tape 150 from the outer diameter side of the adhesive tape roll R1 and, therefore, a slip easily occurs reversely in the tape delay direction (the direction corresponding to the upstream side of the tape feeding direction) relative to the feeding roller 12. For example, when the outer diameter of the core 41 is relatively large, a tension applied to the printed adhesive tape 150″ is made smaller at the time of taking-up by the above described core 41 and, therefore, a slip easily occurs in the tape delay direction relative to the feeding roller 12 in the same way as above. For example, the ambient temperature is relatively low, a mechanical load is increased during operation and, therefore, a slip tends to occur in the tape delay direction relative to the feeding roller 12 in the same way as above.

In these cases, the occurrence of the slip in the tape delay direction makes the tape feeding speed slightly slower between the printing speed and the tape feeding speed that would otherwise be synchronized with each other. As a result, when the slip occurs in the above described tape delay direction, the print is formed in a form shortened in the tape feeding direction as compared to the intended form of print formation and a so-called print length is made shorter.

In this modification example, to deal with the possibility of occurrence of a slip in the above described tape delay direction due to the above described reasons during provision of the constant torque control using the first voltage command value described above, the CPU 212 corrects the value of the voltage command value Vref output to the motor drive circuit 219 from the first voltage command value to the second voltage command value making the drive torque of the second motor M2 larger as compared to the first voltage command value with the same technique as the embodiment etc. The CPU 212 outputs the above described second voltage command value after the correction (larger than the above described first voltage command value) to the motor drive circuit 219, and the motor drive circuit 219 carries out the constant torque control such that the drive torque of the second motor M2 is set to a constant value corresponding to the input second voltage command value.

According to this modification example, a decrease in the tape feeding speed can be prevented even if a slip may otherwise occur in the tape delay direction as described above. As a result, the print formation can be prevented from being in the above described shortened form that may be generated due to a decrease in the tape feeding speed, and the print can be formed in the correct form.

For example, if the tape width is relatively wide, a take-up force of the driven core 41 is distributed in the wide range of the printed adhesive tape 150″ and, therefore, a slip hardly occurs in the tape advance direction. For example, if the tape type is of relatively large friction coefficient such as resin, a slip hardly occurs in the tape advance direction relative to the contacting feeding roller 12. In these cases, the printing speed is relatively identical to the tape feeding speed and a favorable print is formed.

### (5) Others

Although the present disclosure has been described by taking as an example the case that the CPU 212 corrects the value of the voltage command value Vref output to the motor drive circuit 219 to correct the drive torque of the second motor M2 from the first drive torque to the second drive torque, this is not a limitation. For example, the CPU 212 may correct a value of a parameter corresponding to the drive torque of the second motor M2 other than the voltage command value Vref output to the motor drive circuit 219, thereby correcting the drive torque of the second motor M2 from the first drive torque to the second drive torque.

It is noted that terms “vertical,” “parallel,” “plane,” etc. in the above description are not used in the exact meanings thereof. Specifically, these terms “vertical,” “parallel,” and “plane” allow tolerances and errors in design and manufacturing and have meanings of “substantially vertical,” “substantially parallel,” and “substantially plane.”

It is noted that terms “same,” “equal,” “different,” etc. in relation to a dimension and a size of the exterior appearance in the above description are not used in the exact meaning thereof. Specifically, these terms “same,” “equal,” and “different” allow tolerances and errors in design and manufacturing and have meanings of “substantially the same,” “substantially equal,” and “substantially different.” However, when a value used as a predefined determination criterion or a delimiting value is described such as a threshold value and a reference value, the terms “same,” “equal,” “different,” etc. used for such a description are different from the above definition and have the exact meanings.

The arrows shown in FIGS. 7 and 8 indicate an example of signal flow and are not intended to limit the signal flow directions.

The flowcharts shown in FIGS. 12 and 13 are not intended to limit the present disclosure to the shown procedures and the procedures may be added/deleted or may be executed in different order without departing from the spirit and the technical ideas of the disclosure.

The techniques of the embodiment and the modification examples may appropriately be utilized in combination other than those described above.

What is claimed is:

1. A printer comprising:
a storage part configured to store a roll of a tape to be printed wound around an outer circumferential portion of a first core;
a feeding roller;
a printing head that is disposed facing said feeding roller;
a core driving device; and
a controller;
said controller being configured to execute:
a feeding process for driving said feeding roller to contact and feed said tape fed out from said roll stored in said storage part,
a printing process for controlling said printing head to form a desired print at a desired printing speed on said tape fed by said feeding process, thereby turning said tape into a printed tape,
a taking-up process for driving said core driving device to sequentially taking up said printed tape around an outer circumferential portion of a second core into a roll shape, and
a torque correction process for correcting a drive torque of said core driving device from a first drive torque to a second drive torque, the first drive torque corresponding to the absence of a slip between said feeding roller and said tape in contact with said feeding roller, the second drive torque corresponding to a tape remaining amount of said tape in said roll.

2. The printer according to claim 1, wherein
in said torque correction process, the drive torque of said core driving device is corrected from said first drive torque to said second drive torque also in accordance with at least one of a tape width of said tape, a tape type of said tape, and an outer diameter of said second core.

3. The printer according to claim 2, further comprising a constant torque control device configured to perform constant torque control of setting the drive torque of said core driving device to a constant value corresponding to an input command value, wherein
said torque correction process is a command value correction process for correcting said command value output to said constant torque control device from a first command value corresponding to said first drive torque to a second command value corresponding to said second drive torque.

4. The printer according to claim 3, wherein
in said command value correction process, said first command value is corrected to said second command value in accordance with all of said tape remaining amount, said tape width, said tape type, and the outer diameter of said second core.

5. The printer according to claim 3, further comprising a memory configured to store a correction amount table indicating a correction amount corresponding to a combination of said tape remaining amount, said tape width, said tape type, and the outer diameter of said second core, wherein
in said command value correction process, said first command value is corrected to said second command value by referring said correction amount table stored in said memory.

6. The printer according to claim 3, wherein
in said command value correction process, said first command value is corrected to said second command value also in accordance with an ambient temperature.

7. The printer according to claim 1, further comprising a cutter configured to cut said printed tape taken up by said second core to produce one roll-shaped printed material.

8. A printer comprising:
a first storage part configured to store a roll of a tape to be printed wound around an outer circumferential portion of a first core;
a second storage part configured to store a second core;
a feeding roller;
a printing head;
a memory configured to store a tape width of said tape, a tape type of said tape, an outer diameter of said second core, and a tape remaining amount of said tape in said roll and to store a predetermined calculation formula related to said tape width, said tape type, said outer diameter, and said tape remaining amount;
a first motor configured to drive said feeding roller;
a first motor drive circuit configured to drive said first motor;
a second motor configured to drive said second core;
a second motor drive circuit configured to drive said second motor and to make a drive torque of said second motor constant in accordance with a voltage value to be input; and
a controller,
said controller being configured to:
control said first motor drive circuit to drive said first motor for driving said feeding roller to feed said tape in said roll rewound from said first core,
control said printing head for printing on said tape, and
control said second motor drive circuit to drive said second motor for driving said second core to wind a printed tape around said second core,
said controller being configured to input said voltage value represented by
voltage value=reference voltage value×{(100+correction amount)/100}
to said second motor drive circuit to control a torque of said second motor,
said correction amount being calculated by said calculation formula represented by
correction amount=tape width parameter×tape remaining amount parameter+tape type parameter+outer diameter parameter
by using a tape width parameter, a tape remaining amount parameter, a tape type parameter, and an outer diameter parameter correlated with said tape width, said tape remaining amount, said tape type, and said outer diameter, respectively.

9. The printer according to claim 8, wherein
said tape remaining amount parameter is a tape remaining amount ratio acquired by dividing a latest value of said tape remaining amount of said tape in said roll by an initial value of said tape remaining amount of said tape in said roll.

10. The printer according to claim 8, wherein
said first core is included in a tape cartridge having a third core,
said tape includes a separation material layer,
said printer further comprises
a third storage part configured to store said third core;
a third motor configured to drive said third core; and
a third motor drive circuit configured to drive said third motor,
said first storage part is configured to store said roll of said tape cartridge,
said third storage part is configured to store said third core of said tape cartridge,
said controller is further configured to:
control said third motor drive circuit to drive said third motor for rotating said third core to wind around said third core said separation material layer peeled off from said tape.
